(19) United States
(12) Patent Application Publication
(10) Pub. No.: US 2006/0117895 A1
(43) Pub. Date: Jun. 8, 2006

(54) Modular mounting system

(75) Inventor: Conrad Sevenster, Melbourne, Victoria (AU)

Correspondence Address: MORGAN & FINNEGAN, L.L.P., 3 WORLD FINANCIAL CENTER, NEW YORK, NY, 10281-2101, US

(73) Assignee: Oscillating Systems (Pty), Pretoria (ZA)

(21) Appl. No.: 10/513,350

(22) PCT Filed: May 9, 2003
(86) PCT No.: PCT/ZA03/00061

§ 371 Date: Aug. 4, 2005

(30) Foreign Application Priority Data
May 9, 2002 (ZA) 2002/3682

(51) Int. Cl. B25J 18/00

(52) U.S. Cl. 74/490.01

(57) ABSTRACT

The invention concerns a mounting system suitable for mounting drive and driven means [2, 4] of a mechanical power transmission system relative to each other. The mounting system comprises a set of interchangeably connectable modules that can be altered to adapt the same mounting system for various different drive-and-driven means configurations. The system is characterised therein that the modules of the system are interchangeably connectable in such a way that a drive shaft [3] and a driven shaft [5] of drive and driven means [2, 4] mounted, on the mounting system are aligned and orientated parallel to each other in use, and particularly such that shaft shoulders of the drive and driven shafts [3, 5] are aligned, in anyone of the mounting configurations so that there is a straight belt path between the two shafts at all times. The mounting system includes a drive means support base [30, 50, 70, 84, 130], a driven means support base [10] and a Z-adapter base [100] that are interchangeably connectable to each other various different configurations.

### TECHNICAL FIELD

This invention relates to a modular mounting system suitable for supporting a mechanical power transmission system in use. More particularly, but without being limited thereto, the invention relates to a modular mounting system suitable for mounting a drive means, such as an electrical motor, and a driven means, such as a pump, in various mechanical configurations relative to each other such that the respective drive and driven shafts are always in alignment.

### BACKGROUND ART

Mechanical power transmission systems for driving pumps, crushers, floatation cells and the like often comprise driving means, such as an electrical motor including a driver pulley; and driven means, such as a driven pulley that is connected to the pump, crusher, floatation cell or the like to be driven. The driver and driven pulleys are generally operatively associated with one another by means of at least one intermediate belt extending between the pulleys for transmitting mechanical power from the driver to the driven pulley.

It will be appreciated that it is an essential requirement for proper working of any mechanical power transmission system that the drive shaft of the driver pulley remains in constant alignment with the driven shaft of the driven pulley during operation of the mechanical power transmission system. Failure to maintain the drive and driven shafts in alignment would inevitably result in slacking of the belt, change in power load, and non-optimal functioning of the system as a whole.

A mechanical power transmission system for driving pumps, for example, generally comprises at least one electrical motor and at least one pump arranged in mechanical communication with the motor by means of the intermediate belt. Each motor-and-pump configuration is unique and is dependent, inter alia, on the size of the pump, the motor frame size, and available floor space at the site where the configuration is erected.

For space-saving reasons, the motor is generally mounted in an overhead-type configuration relative to the pump, in which the pump is typically secured to the ground. According to one known mounting configuration, a motor support frame including a motor support platform is erected over the pump such that the motor support platform is arranged in vertical spaced orientation above the pump. The motor is then mounted to the motor support platform by means of bolts or the like fastening means such that the motor drive shaft and pump driven shaft are arranged in alignment. According to another mounting system, the motor may be located in an overhead-type configuration relative to the pump by means of a number of jacking bolts extending between a pump support base and the motor support platform.

One of the disadvantages of known motor-and-pump mounting systems is that it is often difficult to mount the motor on the support platform in such a way that the drive and driven shafts of the motor and pump respectively are in alignment with each other for effecting a straight belt path between the same.

Another disadvantage is to adjust the motor support platform relative to the pump such that the motor drive shaft is arranged in parallel orientation relative to the driven shaft of the pump, the difficulty being that if the drive and driven shafts are even slightly angularly orientated relative to each other, the system does not operate efficiently and belt wear increases exponentially. This is particularly problematic in those cases where the motor support platform is supported above the pump on jacking bolts, where an operator is required manually to adjust each of the jacking bolts until the drive and driven shafts are not only perfectly aligned, but are also in perfect parallel orientation, and the belt extending between the two is optimally tensioned.

Yet a further disadvantage is the lack of accessibility to the motor and/or pump and its associated components for maintenance and repair purposes. Known mounting systems are unwieldy, the designs of which provide only limited access to the system components once the system has been erected, which results in problematic, time-consuming and consequently often expensive maintenance and/or replacement procedures.

A further disadvantage is the requirement that a unique motor-and-pump mounting configuration is required and must be built individually for each motor-and-pump combination. Because of the custom-built nature of conventional mounting arrangements for mechanical power transmission systems, a user who elects to change its motor and/or pump sizes, would be obliged also to change the mounting system on which these components are mounted, since the mounting system for one motor-and-pump-arrangement would not be suitable for use with a bigger or smaller, as the case may be, motor-and-pump-arrangement. Naturally, this requirement to have a new mounting system designed, built and erected not only increases erection and general operation costs, but also causes delays in operating times.

Yet a further difficulty experienced with conventional mounting configurations is that the load path is defined through an external foundation. The problem with such an “external” load path is that the foundation becomes dislodged during use, which requires larger and heavier foundations to prevent such dislodgement and to maintain the drive and driven means in position relative to each other in use, which again increases erection costs and times.

### OBJECT OF THE INVENTION

It is accordingly an object of the present invention to provide a novel mounting system suitable for supporting drive and driven means of a mechanical power transmission system that will overcome or at least minimize some of the disadvantages associated with mounting systems of this kind.

It is a further object of the invention to provide a mounting system suitable for a mechanical power transmission system, which enables relatively easy mounting of a drive means and driven means such that the respective drive and driven shafts are both aligned and orientated parallel to each other so as to effect a straight belt path between the shafts.

It is yet a further object of the invention to provide a mounting system suitable for a mechanical power transmission system, which enables unhindered access to the drive and driven means, once the system has been erected, for maintenance, repair and/or replacement purposes.

It is yet a further object of the invention to provide a mounting system suitable for a mechanical power transmission system that can be altered to adapt the same mounting system for various motor-and-pump configurations.

### DISCLOSURE OF THE INVENTION

According to the invention there is provided a mounting system suitable for mounting drive and driven means of a mechanical power transmission system relative to each other, the mounting system comprising a set of interchangeably connectable modules characterised therein that it can be altered to adapt the same mounting system for various different drive-and-driven-means configurations.

The mounting system further may be characterised therein that the modules of the system are interchangeably connectable to each other in such a way that a drive shaft and a driven shaft of drive and driven means mounted on the mounting system are aligned and orientated parallel to each other in use in anyone of the mounting configurations such that there is a straight belt path between the two shafts at all times. More particularly, the system may be characterised therein that shaft shoulders of the drive and driven shafts are aligned in anyone of the mounting configurations.

The modular mounting system may comprise a drive means support base; and a driven means support base, the drive means support base and the driven means support base being characterised therein that they are disconnectably connected to each other in a first mounting configuration to mount the drive and driven means in the first configuration relative to each other, and being re-connectable to each other in a second alternative mounting configuration to mount the drive and driven means in the second configuration.

The driven means support base may removably be securable to the ground or a like rigid surface and may include at least one base platform for supporting the driven means thereon; and engagement means for permitting releasable engagement with the drive means support base. In one form of the invention the driven means support base also may include two opposed side plates and two opposed end plates connected to and extending from the base platform.

The drive means support base may disconnectably be connected either to the ground or a like rigid surface approximate the driven means support base, or to the driven means support base itself and particularly to anyone of the opposed side plates or end plates of the driven means support base. The drive means support base may include a drive beam; at least one mounting plate connected to the drive beam and dimensioned releasably to engage either of the side plates or end plates of the driven means support base; and a drive means receiving platform mechanically linked to the drive beam and suitably dimensioned for receiving the drive means thereon. In one form of the invention the drive means support base may include at least one end-mounting plate connected to an end of the drive beam and at least one side-mounting plate connected to a side of the drive beam.

The drive means receiving platform may be both pivotally displaceable relative to the drive beam, and linearly displaceable parallel to the longitudinal axis of the drive beam.

In one embodiment of the invention the drive beam may comprise of a telescopic shaft and sleeve arrangement. In this embodiment, the drive means receiving platform may be mechanically associated with the telescopic shaft and sleeve arrangement, the arrangement being such that the drive means receiving platform is movable along the longitudinal axis of the drive beam and linearly relative to the base platform through telescoping the drive beam. Telescoping of the shaft and sleeve arrangement of the drive beam may be achieved by means of a threaded rod or the like mechanical adjustment means located in the drive beam; or by means of a hydraulic cylinder arranged within the drive beam for telescoping the same.

The drive means support base may be mounted relative to the driven means support base either in an overhead configuration, in which the drive beam is orientated vertically upright in a plane substantially perpendicular to the plane of the base platform; or in an alongside configuration, in which the drive beam is orientated in substantially the same plane as the base platform. The arrangement may be such that when the drive means support base and driven means support base are orientated in the overhead configuration, the drive means and driven means are substantially vertically spaced from each other, while in the alongside configuration, the drive and driven means are substantially horizontally spaced from each other.

In a preferred embodiment of the invention, the same drive means support base may be mounted relative to the driven means support base in either one of the overhead or alongside configurations. However, in an alternative embodiment, the drive means support base may be selected from one of two designs, namely an overhead drive means support base (“overhead base”) and an alongside drive means support base (“alongside base”).

The drive means support base may include tensioning means, which may be connected to the drive means receiving platform. The tensioning means may be movable between a tensioned and a substantially non-tensioned position such that in the tensioned position it is biased to the non-tensioned position for moving the drive means support base. Particularly, when the tensioning means is in the tensioned position in use, the belt may optimally be tensioned between the drive and driven means, and when the tensioning means is in the substantially non-tensioned position, the belt may non-optimally be tensioned.

The tensioning means may be resilient biasing means that is flexible between a tensioned and substantially non-tensioned position. The resiliently flexible biasing means may be any suitable spring, torsion element or the like, such as a Neidhart unit. It will be appreciated that the Neidhart unit is a torsion element comprising an elongate shaft trapped within a concentrically orientated elongate sleeve, together with a number of resiliently flexible elements located intermediate an outside of the shaft and an interior face of the sleeve. The shaft and the sleeve, which are generally of triangular or square cross-section, are longitudinally off-set relative to each other by approximately 60° (for triangular cross-section) or 45° (for square cross-section), thus defining either three or four elongate bores intermediate the shaft and the sleeve. The resiliently flexible elements, which are generally elongate rubber elements, are located in these bores, the arrangement being such that when the shaft is rotated about its longitudinal axis relative to the sleeve the elements are substantially resiliently deformed, thus creating rotational tension on the shaft in an opposite direction.

The modular mounting system may include pre-stressing means adapted for effecting displacement of the drive means receiving platform relative to the base platform for manipulating distance between drive and driven means mounted on these respective platforms, thereby manipulating belt tension of a belt extending between the drive and driven means in use. The pre-stressing means may be adapted to move the drive means receiving platform while at the same time moving the tensioning means towards its tensioned position.

In one form of the invention, the pre-stressing means may be a hydraulically operable arm pivotally connected at one end thereof to the drive beam and pivotally connected at an opposite end thereof to the drive means receiving platform, the arrangement being such that extension and retraction of the hydraulic arm effects pivoting of the drive means receiving platform about the drive beam.

The modular mounting system may be characterised therein that the pre-stressing means is self-adjusting and adapted for continuously moving at least the drive means receiving platform substantially immediately upon occurrence of belt slacking while the belt is running. The modular mounting system may further be characterised therein that drive means receiving platform is manually adjustable relative to the driven means support base while the belt is running.

The modular mounting system further may include a Z-adapter base which is locatable intermediate the drive means support base and the driven means support base such that the drive means support base and the driven means support base are arranged relative to each other in a Z-configuration.

The Z-adapter base may be locatable between the drive and driven means support bases either in a Z-overhead configuration, in which the drive beam is orientated vertically upright in a plane substantially perpendicular to the plane of the base platform; or in a Z-alongside configuration, in which the drive beam is orientated in substantially the same plane as the base platform. More particularly, in the Z-overhead configuration the side-mounting plate of the drive means support base is connected to the Z-adapter base, which in turn is connected to the driven means support base in such a way that the drive means and driven means are substantially vertically spaced from each other in a Z-configuration; whereas in the Z-alongside configuration the end-mounting plate of the drive means support base is connected to the Z-adapter base, which in turn is connected to the driven means support base such that the drive and driven means are substantially horizontally spaced from each other in a Z-configuration.

The Z-adapter base may include a base plate orientated in substantially the same plane as the base platform, two opposed side plates and two opposed end plates connected to the base plate, and engagement means suitable for engaging the drive and driven means support bases. The drive and driven means support bases may disconnectably be connected to the Z-adapter base such that the drive means support base is connected to either one of the side or end plates of the Z-adapter base, while the driven means support base is connected to either one of the other of the end or side plates of the Z-adapter base, as the case may be. So, for example, if the drive means support base is connected to a side plate of the Z-adapter base, then the driven means support base is connected to one of the end plates of the Z-adapter base.

In a preferred form of the invention the mounting system may thus comprise of three basic modules which are disconnectably connectable to each other, namely the drive means support base; the driven means support base; and the Z-adapter base. These modules may engage each other either in one of the standard configurations, which is characterised therein that the drive means support base is connected directly to the driven means support base; or in one of the Z-configurations, which is characterised therein that the drive means support base is connected to the Z-adapter base, which in turn is connected to the driven means support base.

Furthermore, the standard configurations may include the standard overhead configuration, where the drive means support base is mounted to the driven means support base such that the drive beam is orientated vertically upright in a plane substantially perpendicular to the plane of the base platform; or in a standard alongside configuration, in which the drive beam is orientated in substantially the same plane as the base platform.

Similarly, Z-configurations may include the Z-overhead configuration in which the side-mounting plate of the drive means support base is connected to the Z-adapter base, which in turn is connected to the driven means support base in such a way that the drive means and driven means are substantially vertically spaced from each other in a Z-configuration; and the Z-alongside configuration in which the end-mounting plate of the drive means support base is connected to the Z-adapter base, which in turn is connected to the driven means support base such that the drive and driven means are substantially horizontally spaced from each other in a Z-configuration.

The modular mounting system also may include at least one belt guard to prevent injury to operators. The belt guard, which is adapted at least partially to cover the belt extending between the drive and driven means, may include at least two opposed parallel sidewalls spaced from each other to define a belt path between them suitable for housing the belt and is characterised therein that it provides access to the belt in use. The belt guard is releasably connected to either one or both of the drive and driven means support bases.

According to another aspect of the invention there is provided a drive means support base suitable for cooperating with a driven means support base in a modular mounting system, the drive means support base comprising a drive beam; mounting means connected to the drive beam for mounting the drive means support base either to the ground or the like rigid surface, or to the driven means support base; and a drive means receiving platform mechanically linked to the drive beam and suitably dimensioned for receiving the drive means thereon.

The drive means support base may include tensioning means connected to the drive means receiving platform and movable between a tensioned and a substantially non-tensioned position such that in the tensioned position it is biased to the non-tensioned position for moving the drive means receiving platform.

The drive means support base also may include pre-stressing means. The pre-stressing means may be adapted for effecting displacement of the drive means receiving platform relative to the driven means support base for manipulating distance between drive and driven means respectively mounted on the drive means receiving platform and the driven means support base, thereby manipulating belt tension of a belt extending between the drive and driven means in use. The pre-stressing means may be adapted to move the drive means receiving platform while at the same time moving the tensioning means towards its tensioned position.

According to another aspect of the invention there is provided a Z-adapter base suitable for use in a modular mounting system, the Z-adapter base being locatable intermediate a drive means support base and a driven means support base such that the drive and driven means support bases are arranged relative to each other in a Z-configuration.

The Z-adapter base may include a base plate, two opposed side plates and two opposed end plates connected to the base plate, and engagement means suitable for engaging the drive and driven means support bases. The drive and driven means support bases may disconnectably be connected to the Z-adapter base such that the drive means support base is connected to either one of the side or end plates of the Z-adapter base, while the driven means support base is connected to either one of the other of the end or side plates of the Z-adapter base, as the case may be.

### SPECIFIC EMBODIMENT OF THE INVENTION

Without limiting the scope thereof, the invention will now further be described in light of the following examples and with reference to the accompanying drawings wherein—

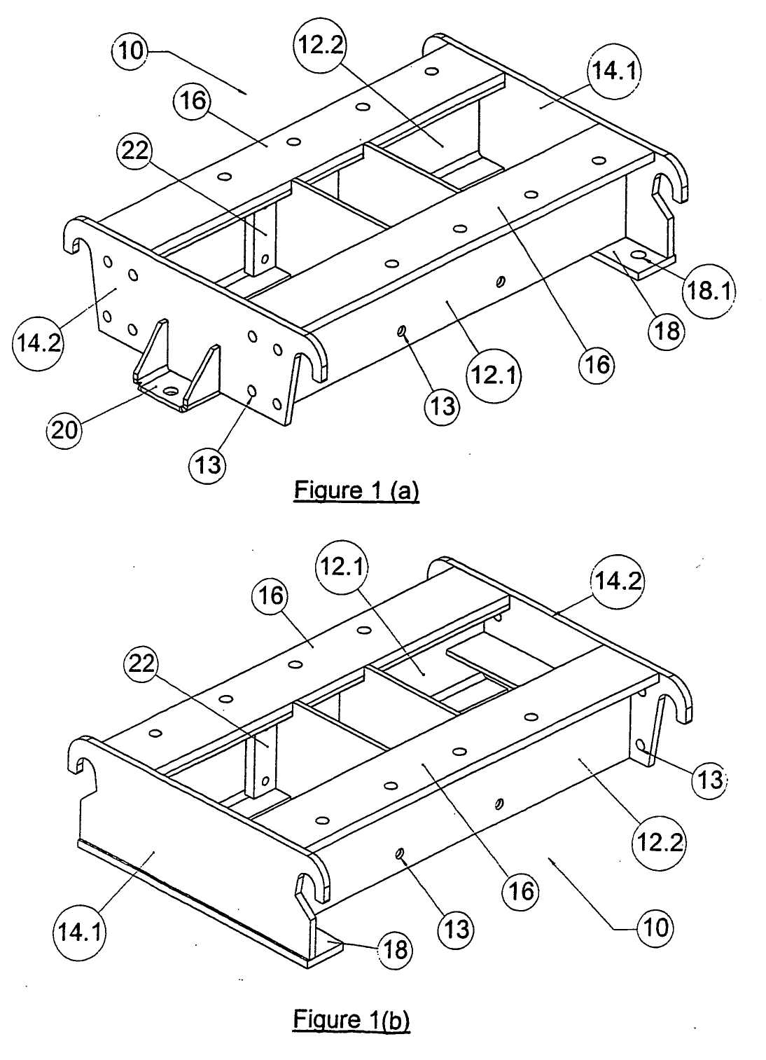

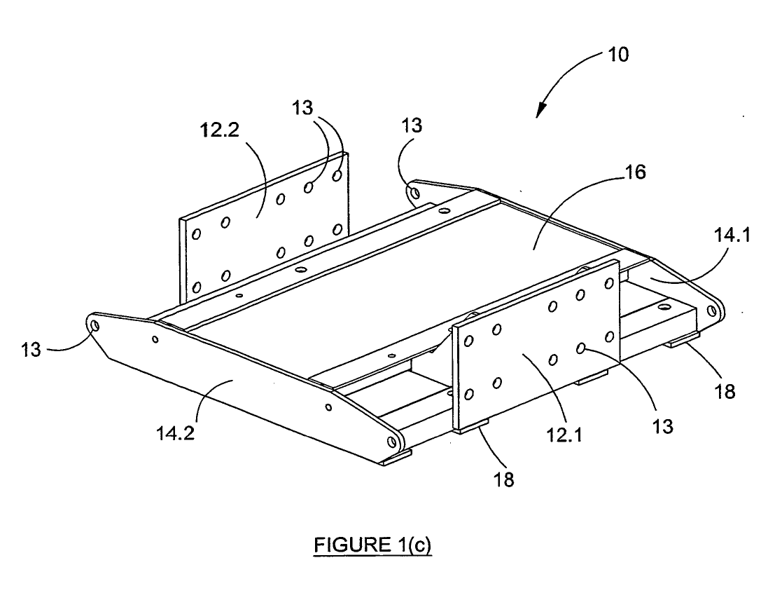

FIG. 1(a) is an isometric view from one end of a driven means support base according to one embodiment of the invention;

FIG. 1(b) is an isometric view from the opposite end of the driven means support base of FIG. 1(a);

FIG. 1(c) is an isometric view of a driven means support base according to an alternative embodiment of the invention;

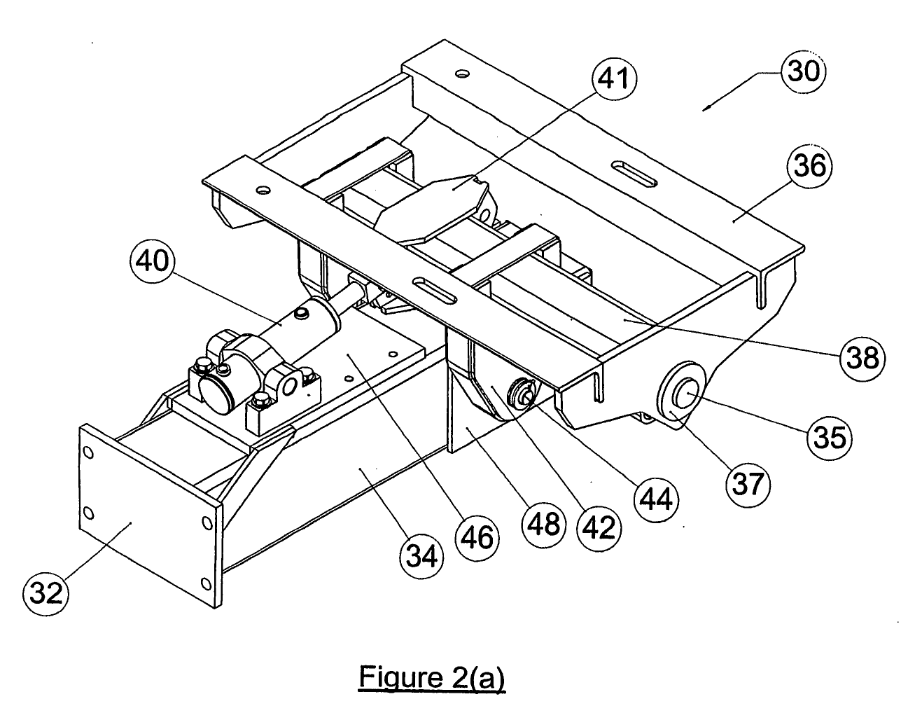

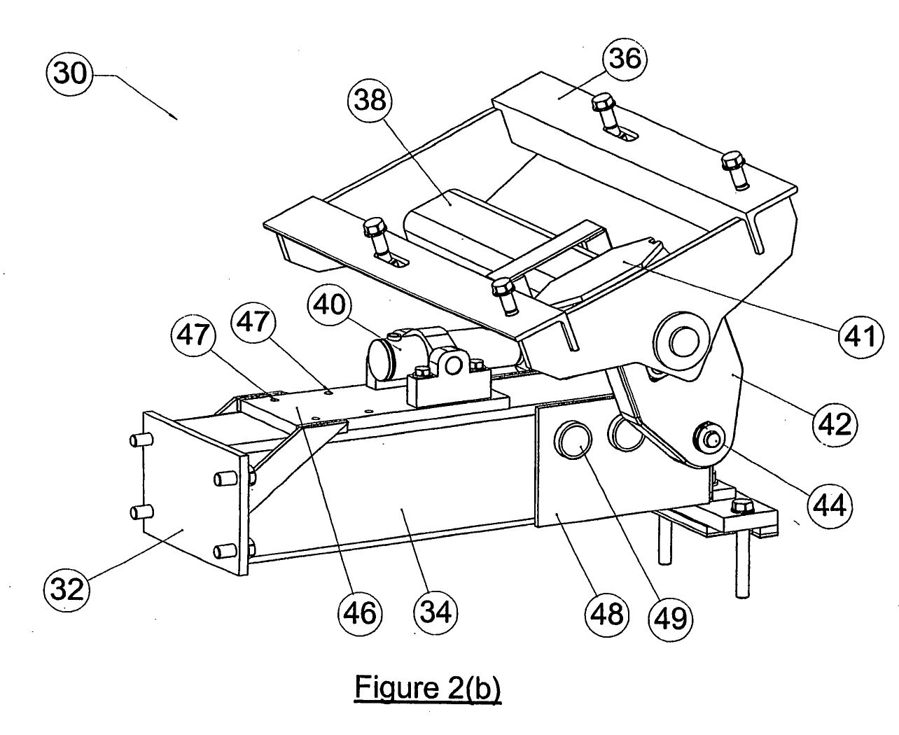

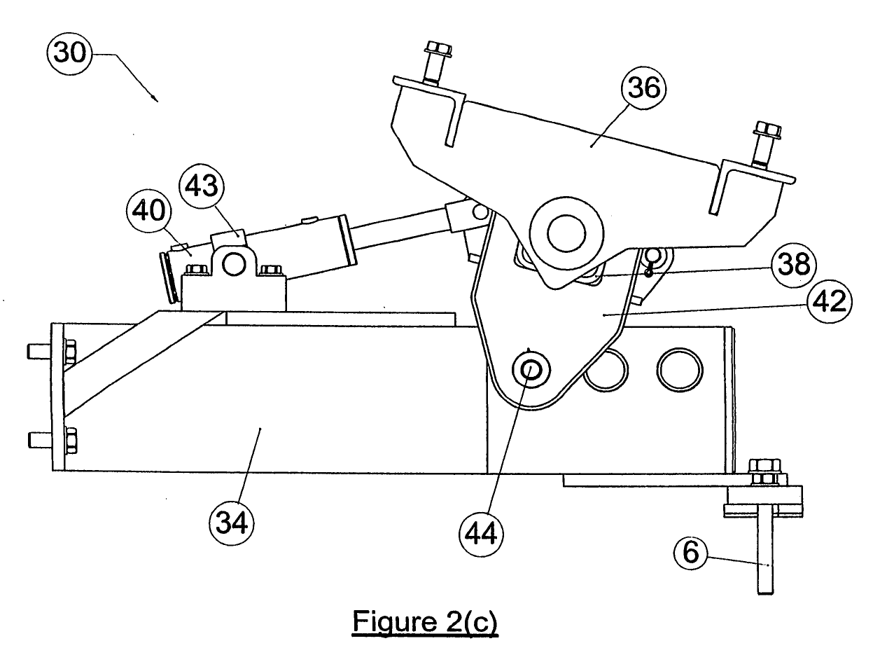

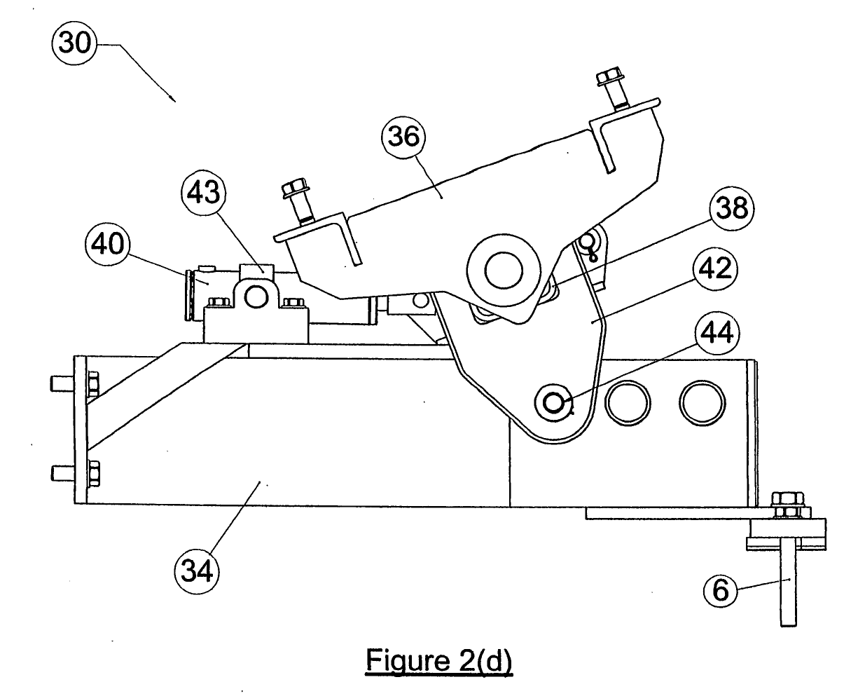

FIG. 2(a) is an isometric view of an alongside drive means support base (“alongside base”) according to one embodiment of the invention, wherein the alongside base is suitable for accommodating drive means of larger frame sizes;

FIG. 2(b) is an isometric view of the alongside base of FIG. 2(a) illustrating alternative possible positions of the pre-stressing means and the drive means receiving platform on the drive beam;

FIG. 2(c) are side view illustrations of the alongside base of FIGS. 2(a) and 2(b), and 2(d) illustrating working of the pre-stressing means and the pivoting action of the drive means receiving platform;

FIG. 3 is an isometric view of an alongside drive means support base (“alongside base”) according to an alternative embodiment of the invention, wherein the alongside base is suitable for accommodating drive means of smaller frame sizes;

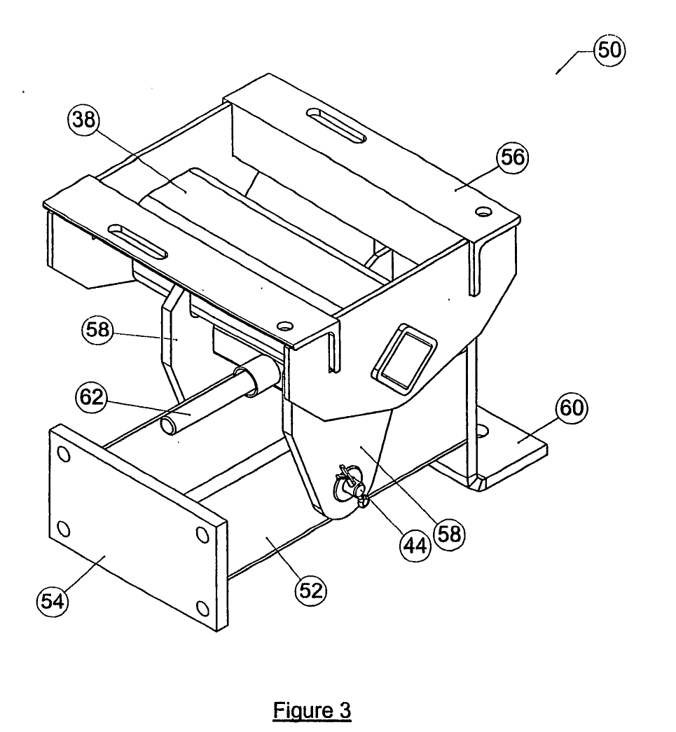

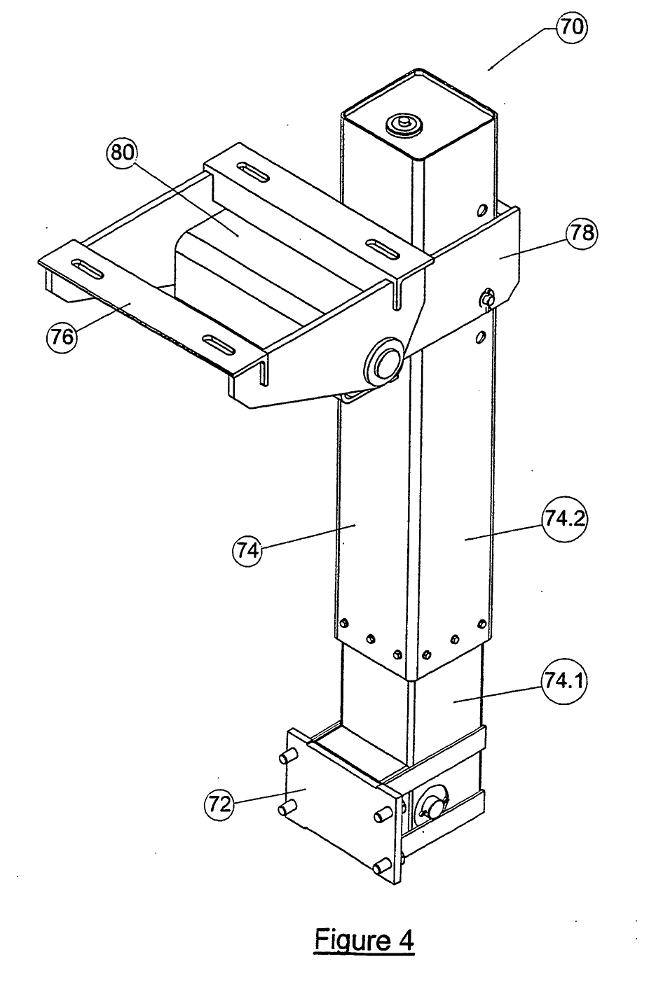

FIG. 4 is an isometric view of an overhead drive means support base (“overhead base”) according to one embodiment, wherein the overhead base is suitable for accommodating drive means of larger frame sizes;

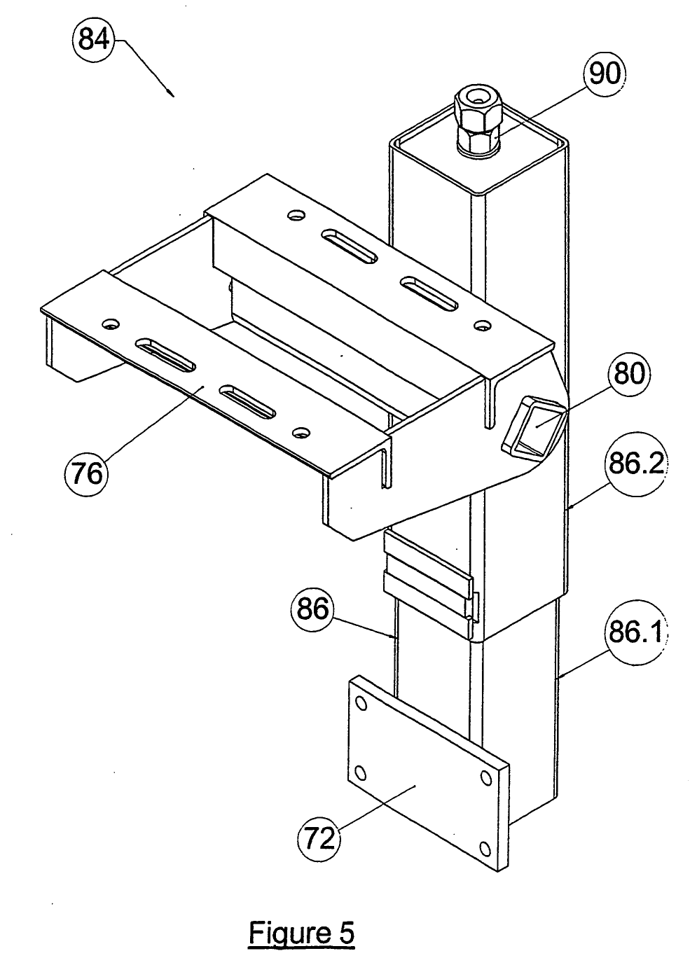

FIG. 5 is an isometric view of an overhead drive means support base (“overhead base”) according to an alternative embodiment, wherein the overhead base is suitable for accommodating drive means of smaller frame sizes;

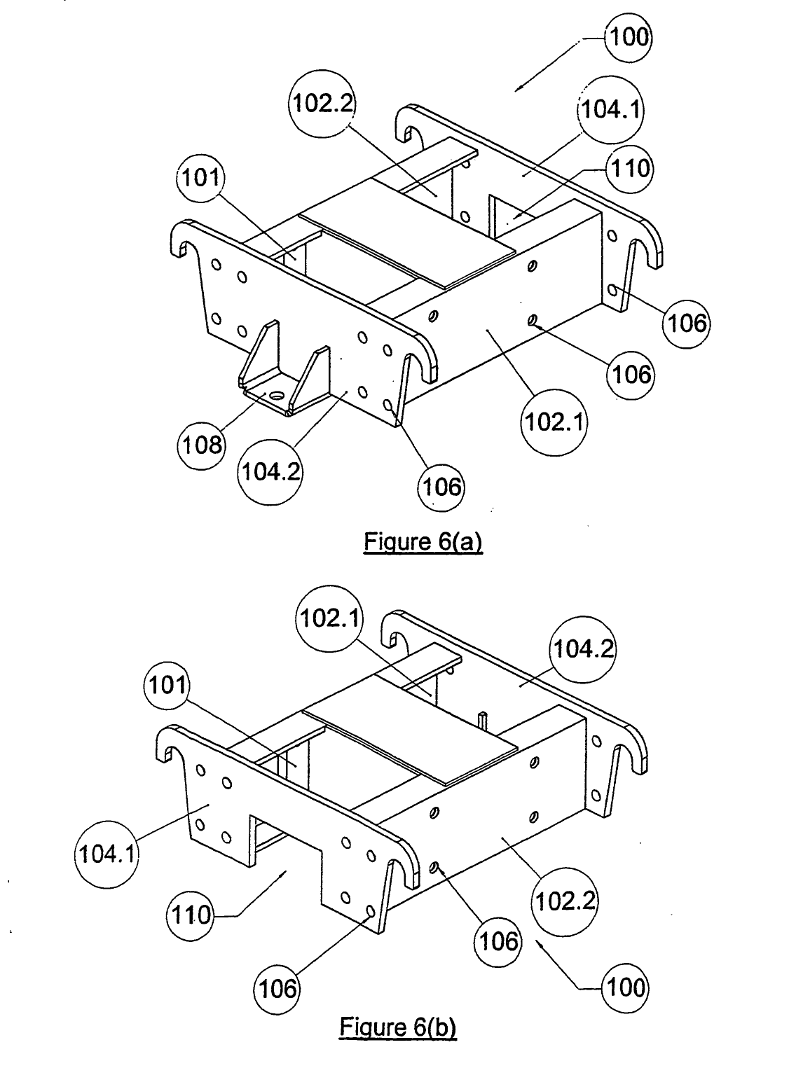

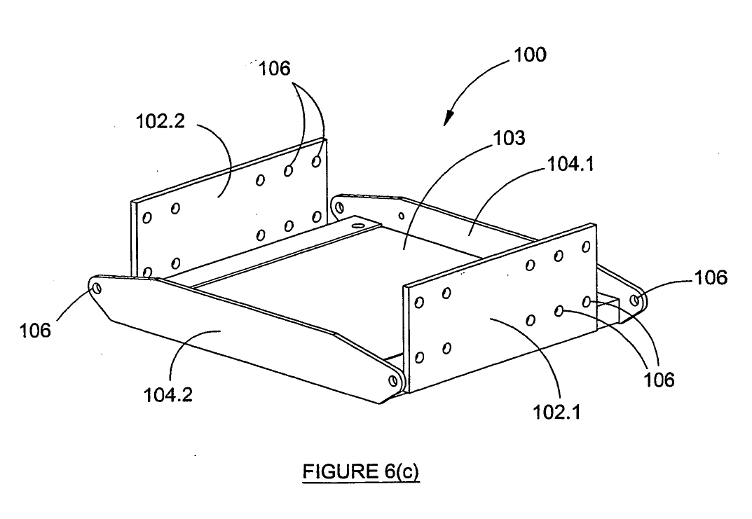

FIG. 6(a) is an isometric view from one end of a Z-adapter base according to one embodiment of the invention;

FIG. 6(b) is an isometric view from the opposite end of the Z-adapter base of FIG. 6(a);

FIG. 6(c) is an isometric view of a Z-adapter base according to an alternative embodiment of the invention;

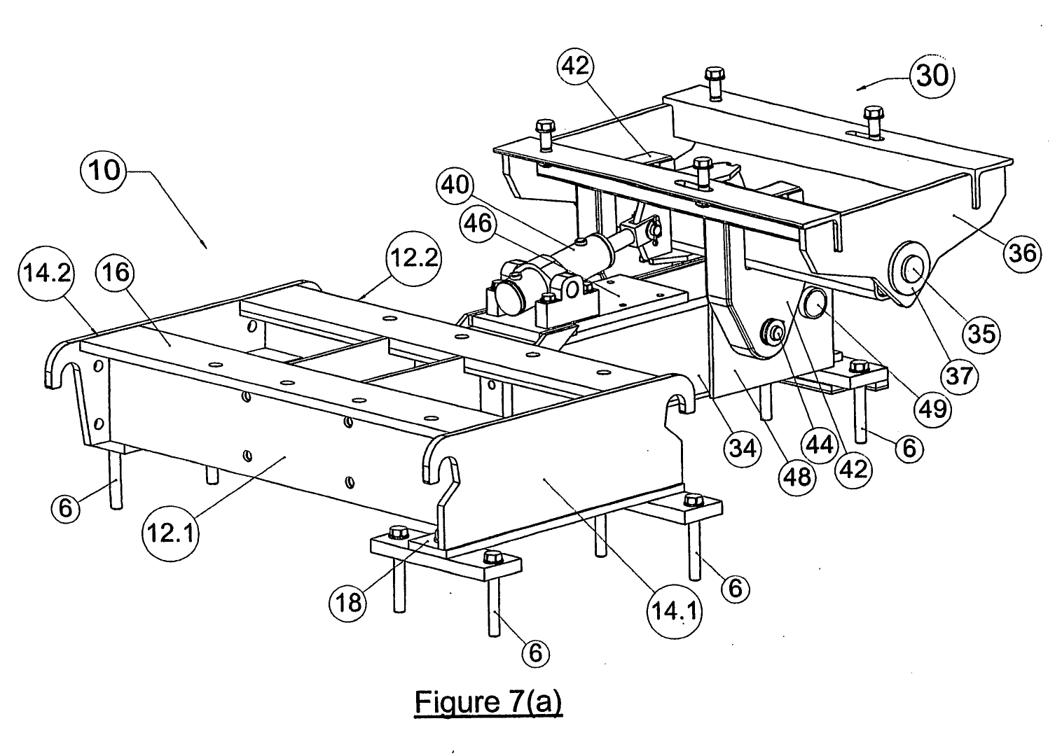

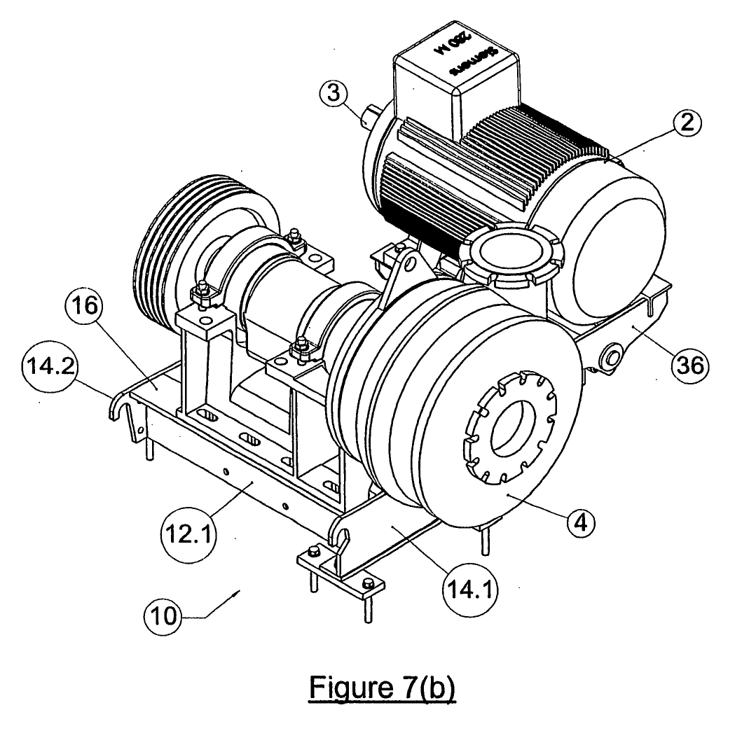

FIG. 7(a) is an isometric view of an alongside base according to one embodiment of the invention, connected to a side plate of a driven means support base in a so-called “standard alongside configuration”;

FIG. 7(b) is an isometric view of the standard alongside configuration of FIG. 7(a) with a motor and pump mounted respectively to the drive means support base and the driven means support base;

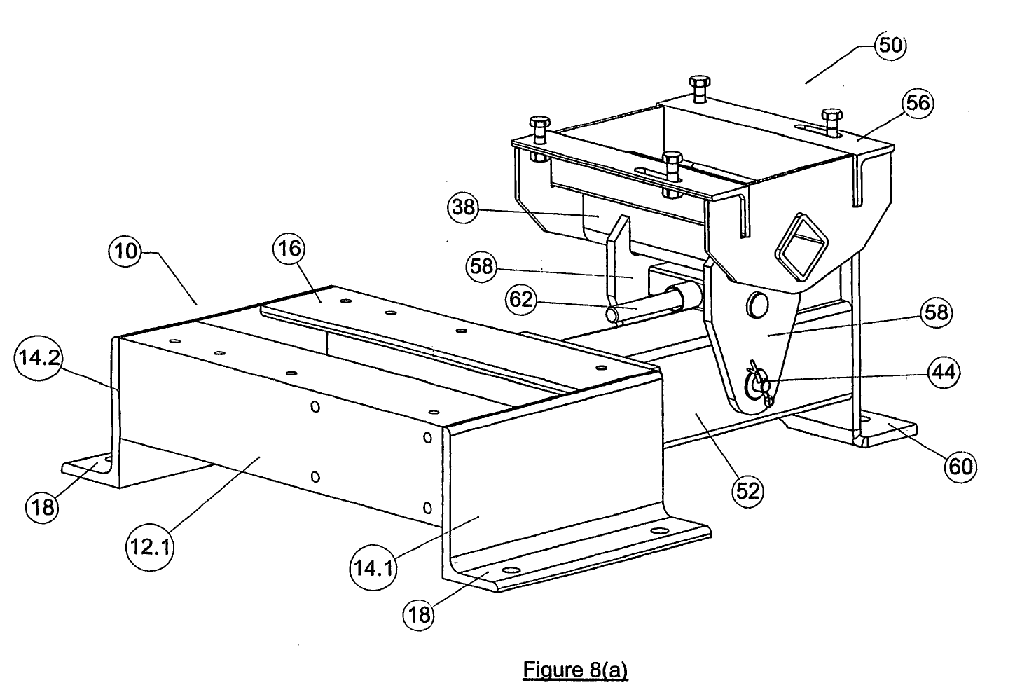

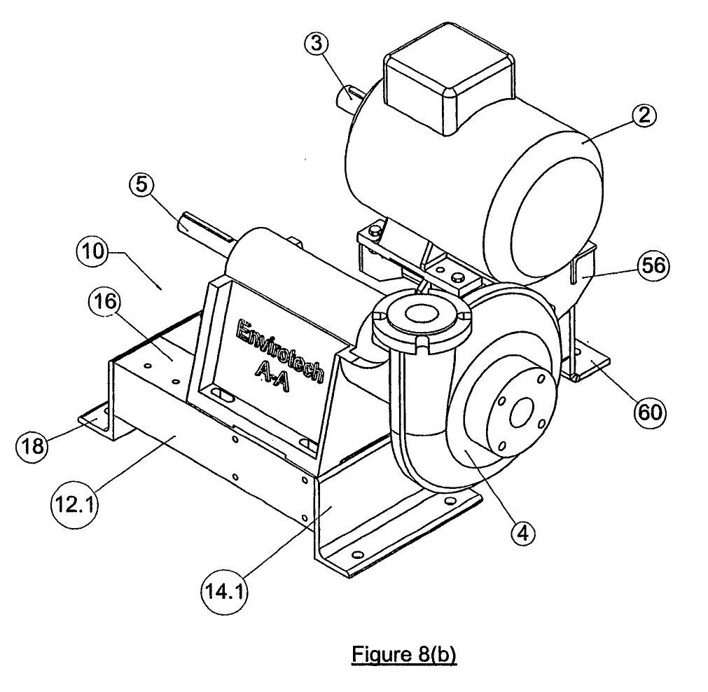

FIG. 8(a) is an isometric view of an alongside base according to another embodiment of the invention (i.e. for accommodating drive means of smaller frame sizes) that is connected to a side plate of a driven means support base in a standard alongside configuration;

FIG. 8(b) is an isometric view of the standard alongside configuration of FIG. 8(a) with a motor and pump mounted respectively on the drive means support base and the driven means support base;

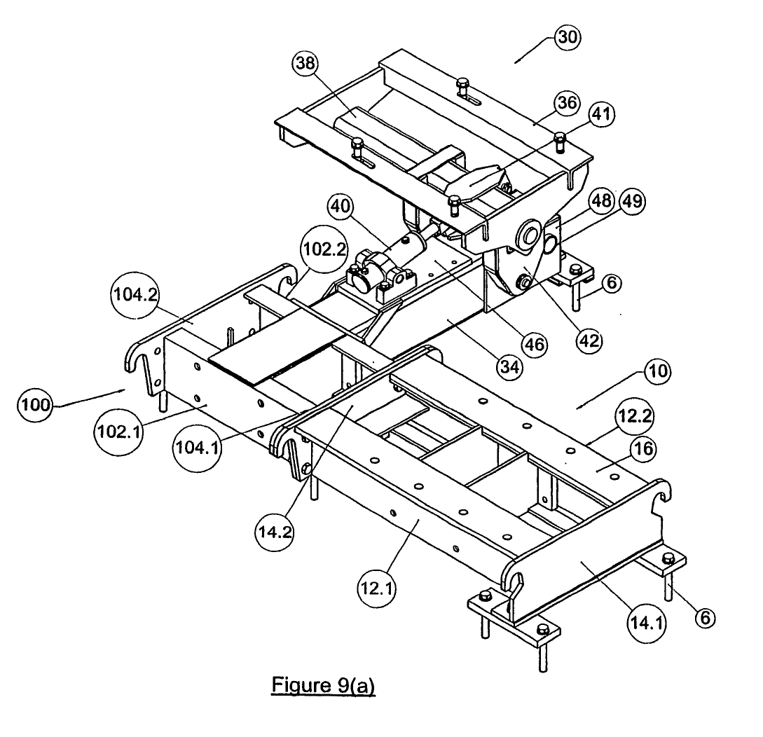

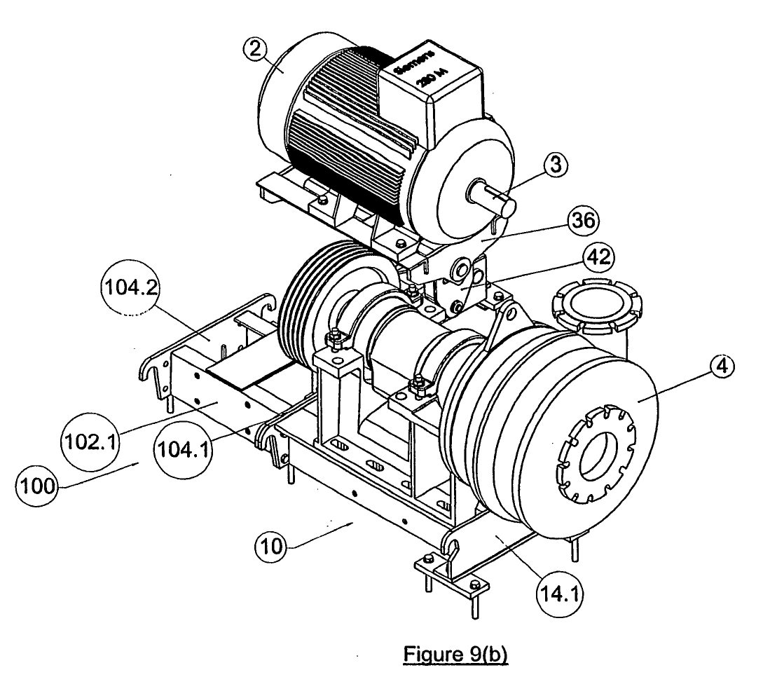

FIG. 9(a) is an isometric view of an alongside base according to one embodiment of the invention, which is connected to a driven means support base by means of an intermediately located Z-adapter base in a so-called “Z-alongside configuration”;

FIG. 9(b) is an isometric view of the Z-alongside configuration of FIG. 9(a) with a motor and pump mounted respectively to the drive means support base and the driven means support base;

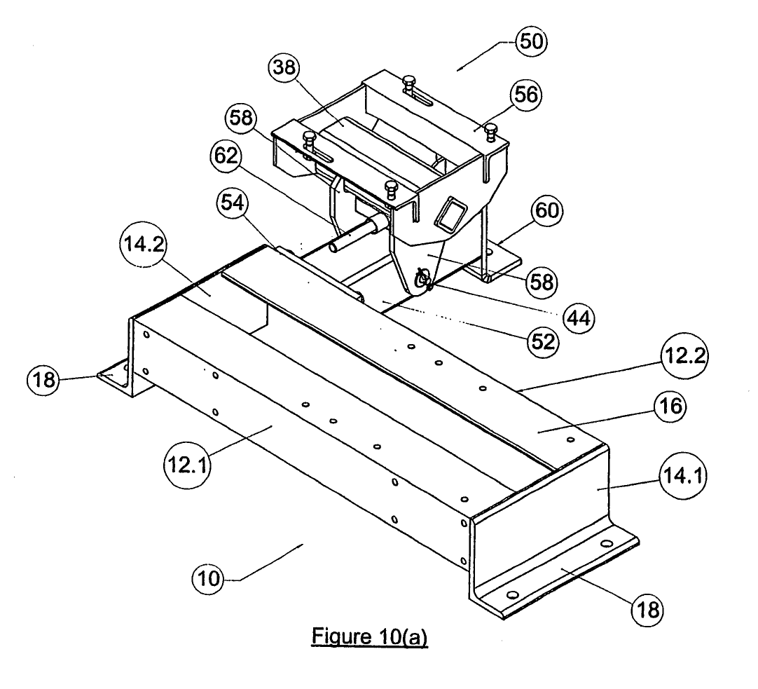

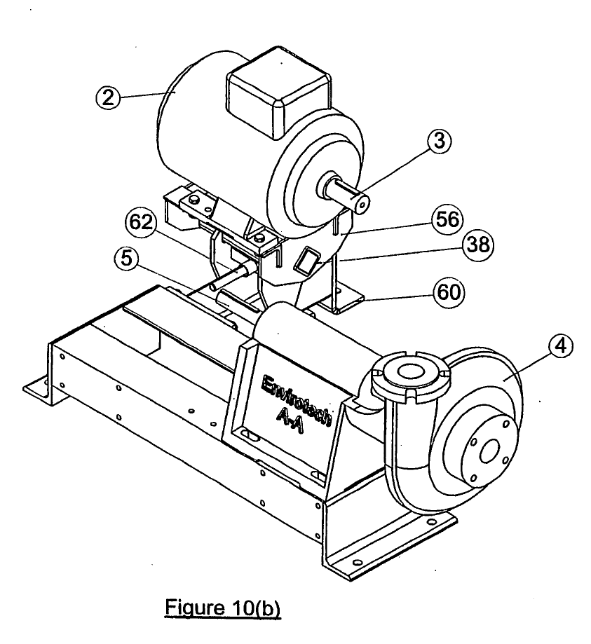

FIG. 10(a) is an isometric view of an alongside base according to another embodiment of the invention (i.e. for accommodating drive means of smaller frame sizes), which is connected to a driven means support base in a Z-alongside configuration;

FIG. 10(b) is an isometric view of the Z-alongside configuration of FIG. 10(a) with a motor and pump mounted respectively to the drive means support base and the driven means support base;

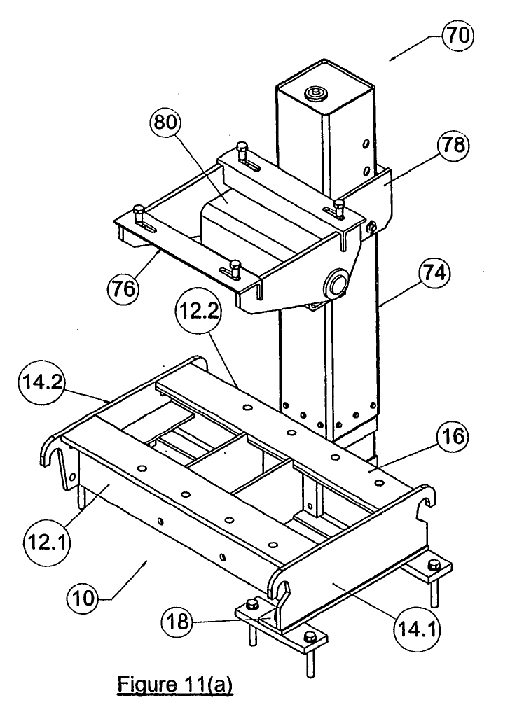

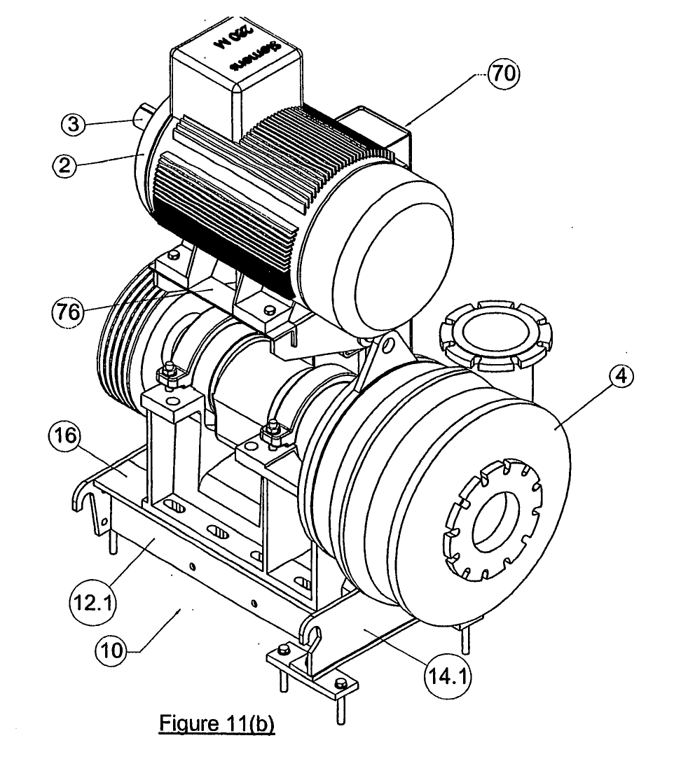

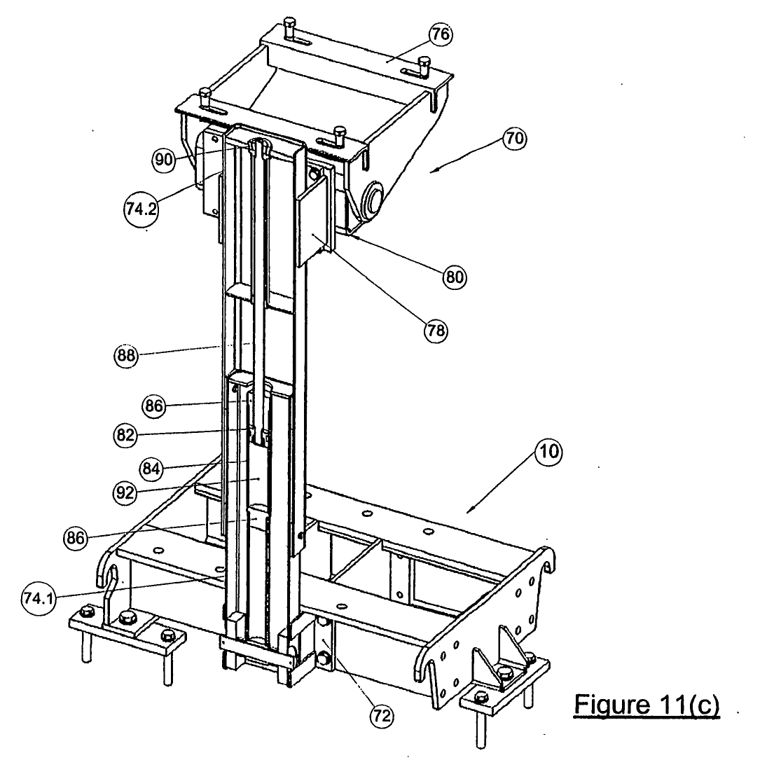

FIG. 11(a) is an isometric view of an overhead base according to one embodiment of the invention that is connected to a side plate of a driven means support base in a so-called “standard overhead configuration”;

FIG. 11(b) is an isometric view of the standard overhead configuration of FIG. 11(a) with a motor and pump mounted respectively to the overhead base and the driven means support base;

FIG. 11(c) is a partially sectioned isometric rear view of the standard overhead configuration of FIGS. 11(a) and (b), illustrating the hydraulic cylinder in the telescopic drive beam;

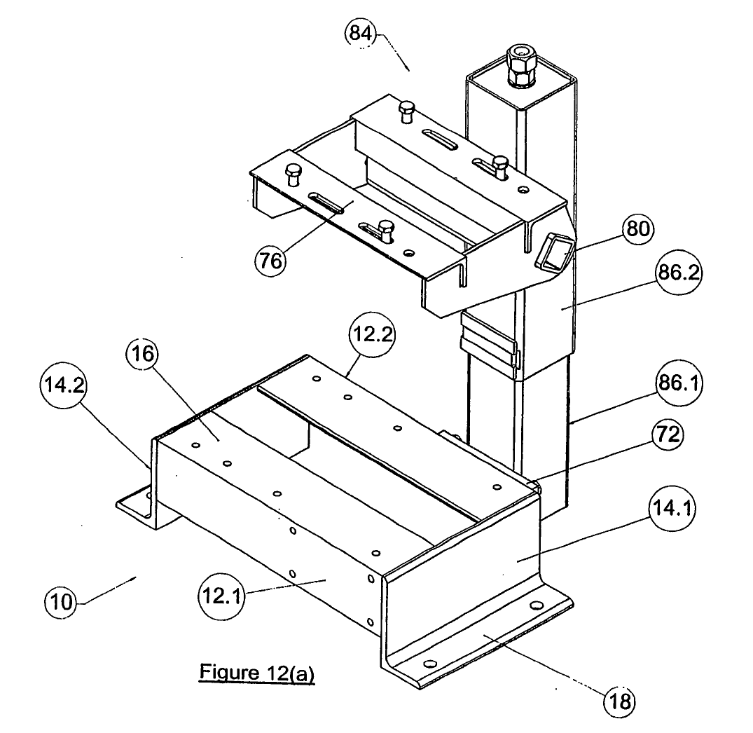

FIG. 12(a) is an isometric view of an overhead base according to another embodiment of the invention (i.e. for accommodating drive means of smaller frame sizes) that is connected to a side plate of a driven means support base in a standard overhead configuration;

FIG. 12(b) is an isometric view of the standard overhead configuration of FIG. 12(a) with a motor and pump mounted respectively to the overhead base and the driven means support base;

FIG. 12(c) is an isometric view from below of the standard overhead configuration of FIGS. 12(a) and (b), illustrating the tensioning means;

FIG. 12(d) is a partially sectioned isometric rear view of the standard overhead configuration of FIGS. 12(a) to (c), illustrating the threaded rod pre-stressing means;

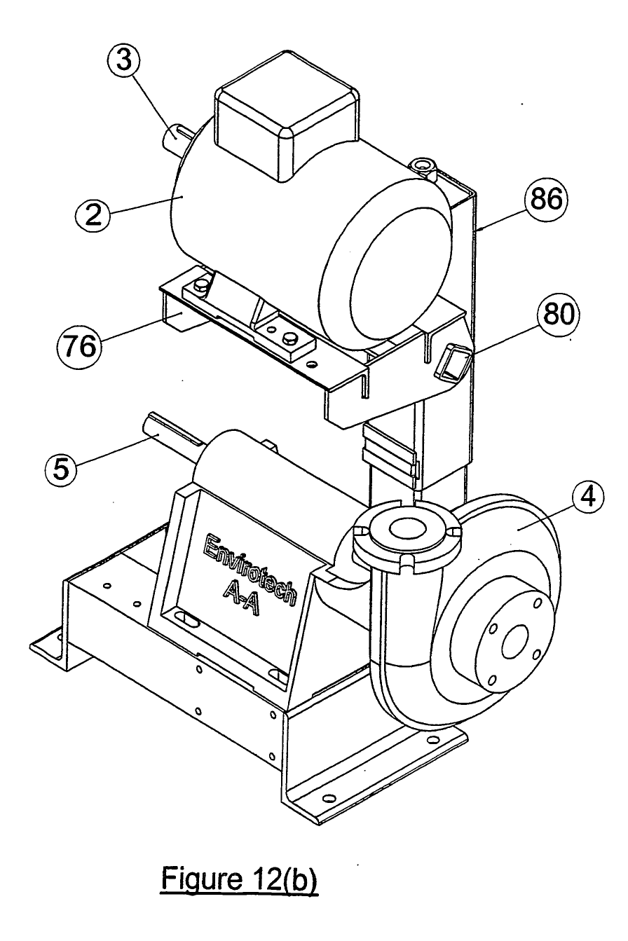

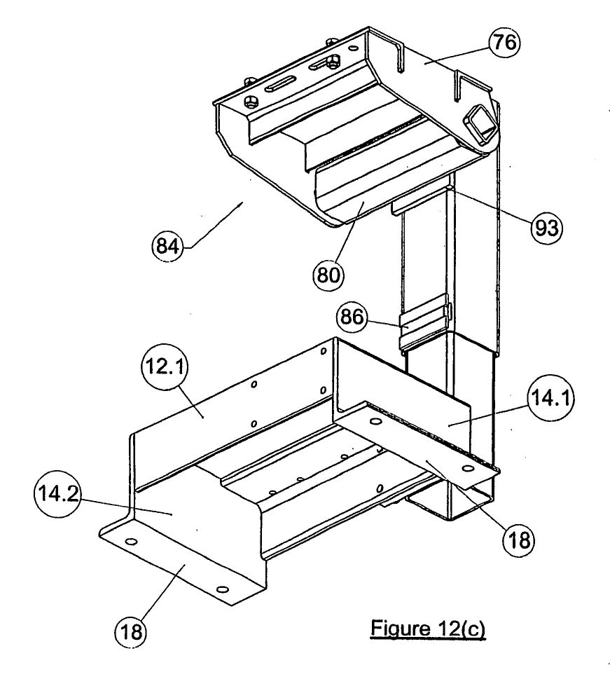

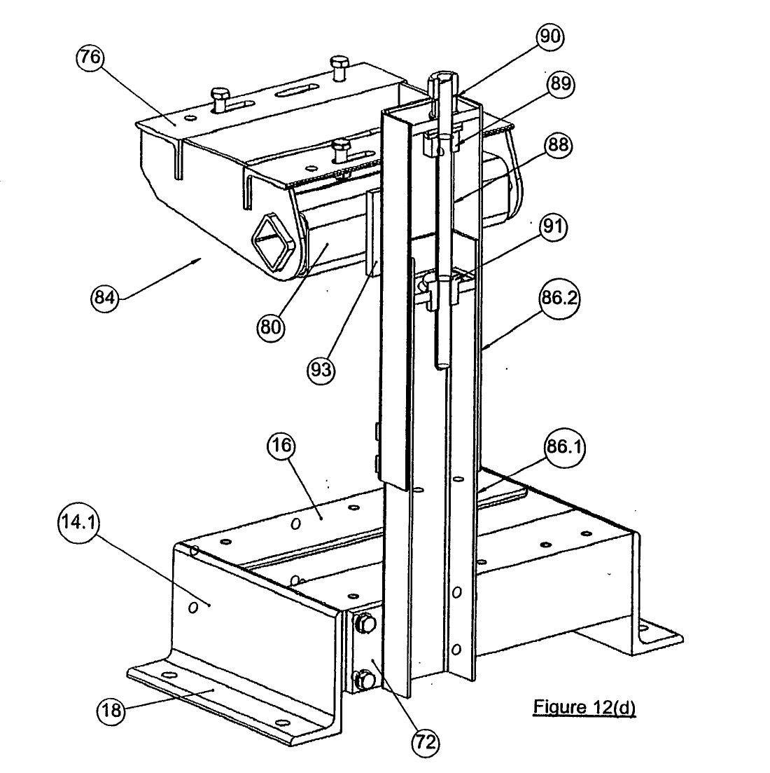

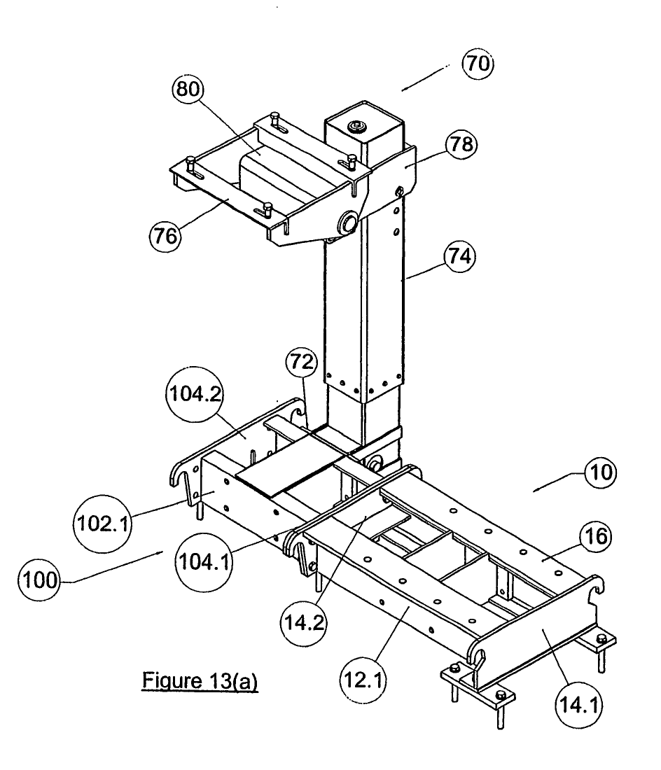

FIG. 13(a) is an isometric view of an overhead base according to one embodiment of the invention, which is connected to a driven means support base by means of an intermediately located Z-adapter base in a so-called “Z-overhead configuration”;

FIG. 13(b) is an isometric view of the Z-overhead configuration of FIG. 13(a) with a motor and pump mounted respectively to the overhead base and the driven means support base;

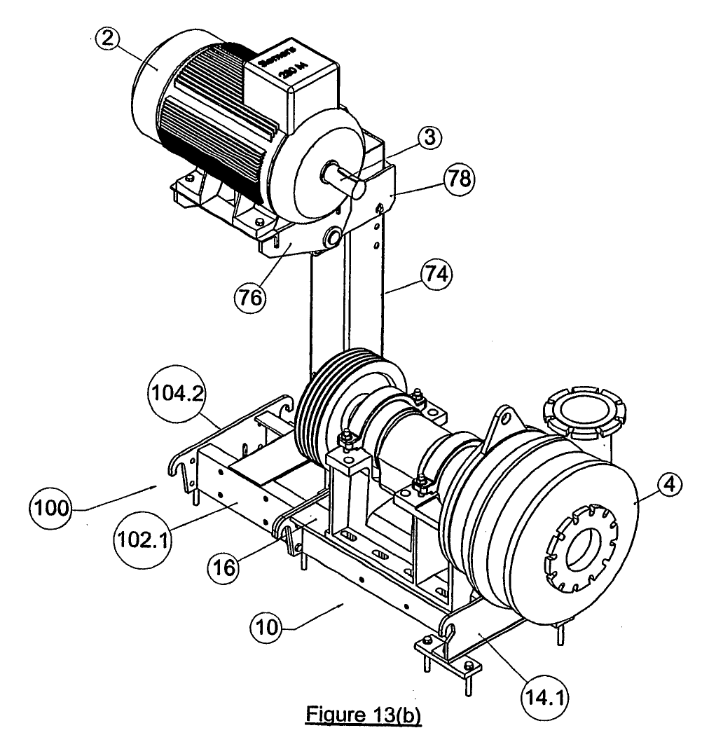

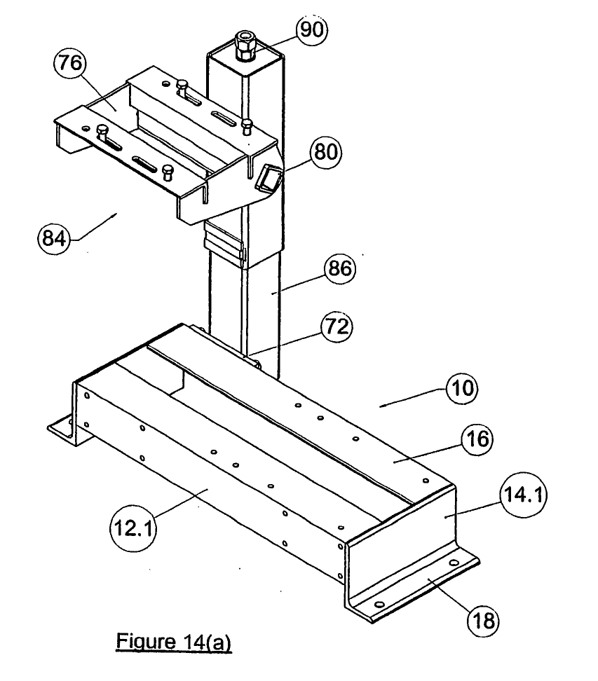

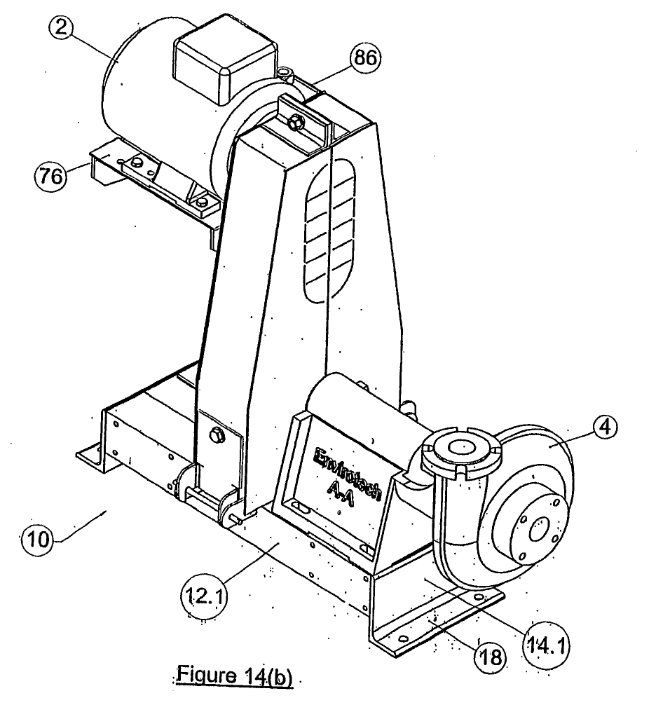

FIG. 14(a) is an isometric view of an overhead base according to another embodiment of the invention (i.e. for accommodating drive means of smaller frame sizes), which is connected to a driven means support base in a Z-overhead configuration;

FIG. 14(b) is an isometric view of the Z-overhead configuration of FIG. 14(a) with a motor and pump mounted respectively to the overhead base and the driven means support base, also illustrating a belt guard mounted to the driven means support base;

FIG. 15(a) is an isometric view of a drive means support base which is adapted to work in either one of an overhead or alongside configuration relative to the driven means support base, FIG. 15(a) illustrating the positioning of the drive means support base when it is used in the overhead configuration;

FIG. 15(b) is a side view of the drive means support base of FIG. 15(a) with the hydraulic pre-stressing arm in an extended position;

FIG. 15(c) is an isometric view of the drive means support base of FIGS. 15(a) and (b), illustrating positioning of the drive means support base, and an alternative orientation of the drive means receiving platform, when this support base is used in the alongside configuration;

FIG. 16(a) is an isometric view of the drive means support base of FIG. 15(c) and the driven means support base of FIG. 1(c) that are connected to each other in a first possible standard alongside configuration, and also illustrates an embodiment of a belt guard according to the invention;

FIG. 16(b) is an isometric view of the drive means support base of FIG. 15(c) and the driven means support base of FIG. 1(c), which are now connected to each other in a second possible standard alongside configuration;

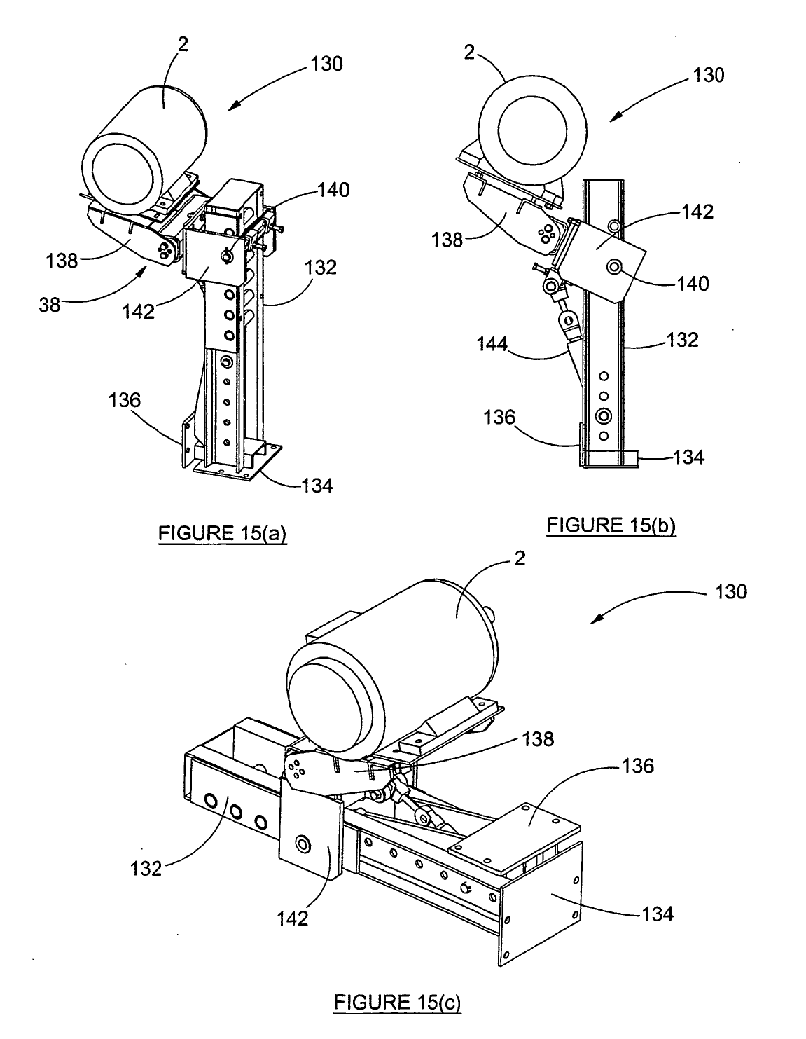

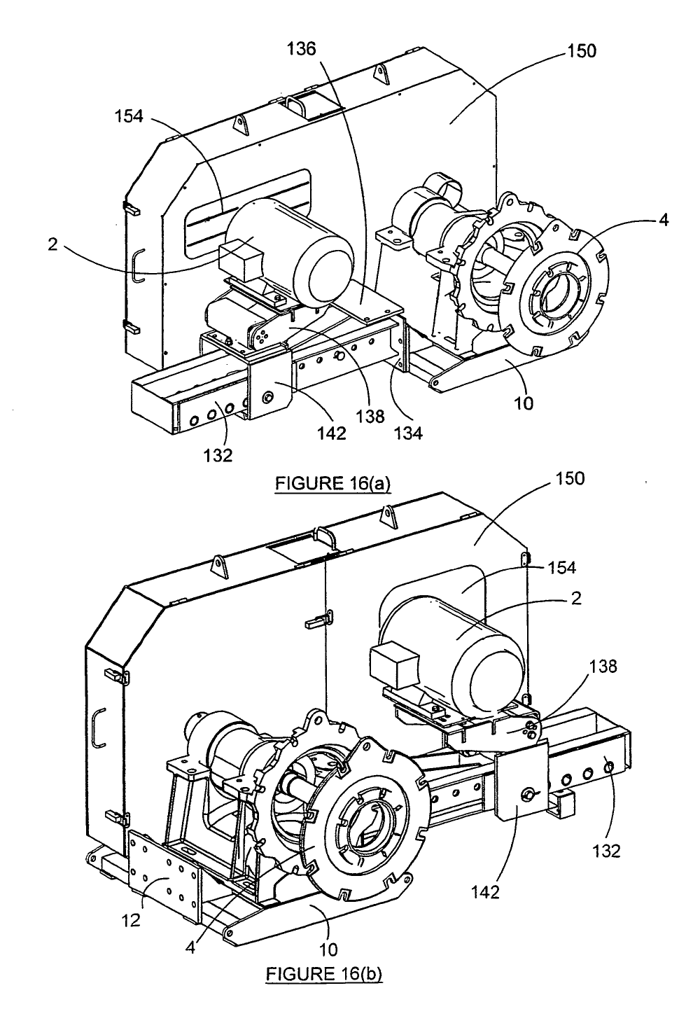

FIG. 17(a) is an isometric view of the drive means support base of FIGS. 15(a) and (b) and the driven means support base of FIG. 1(c), connected to each other in a first possible standard overhead configuration, and also illustrates an alternative embodiment of a belt guard;

FIG. 17(b) is an isometric view of the drive means support base of FIGS. 15(a) and (b) and the driven means support base of FIG. 1(c), which are connected to each other in a second possible standard overhead configuration;

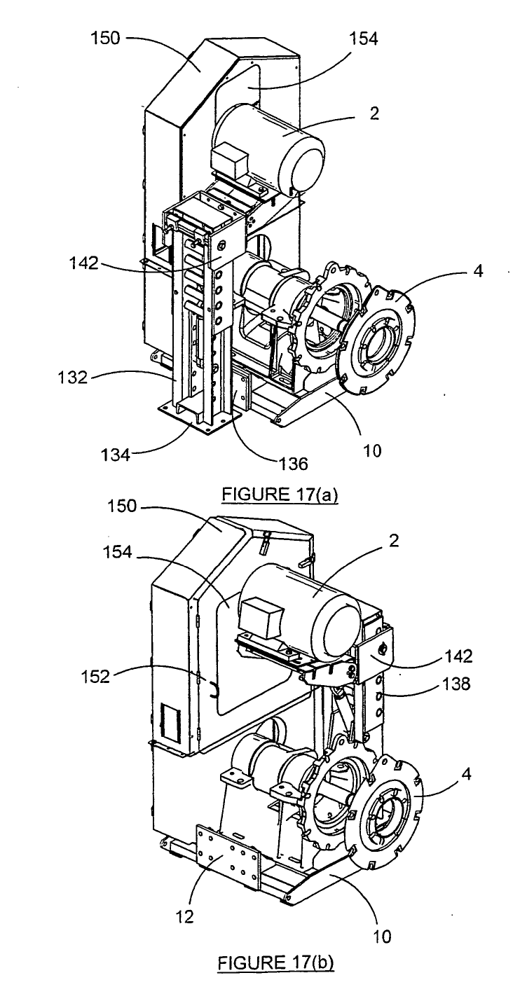

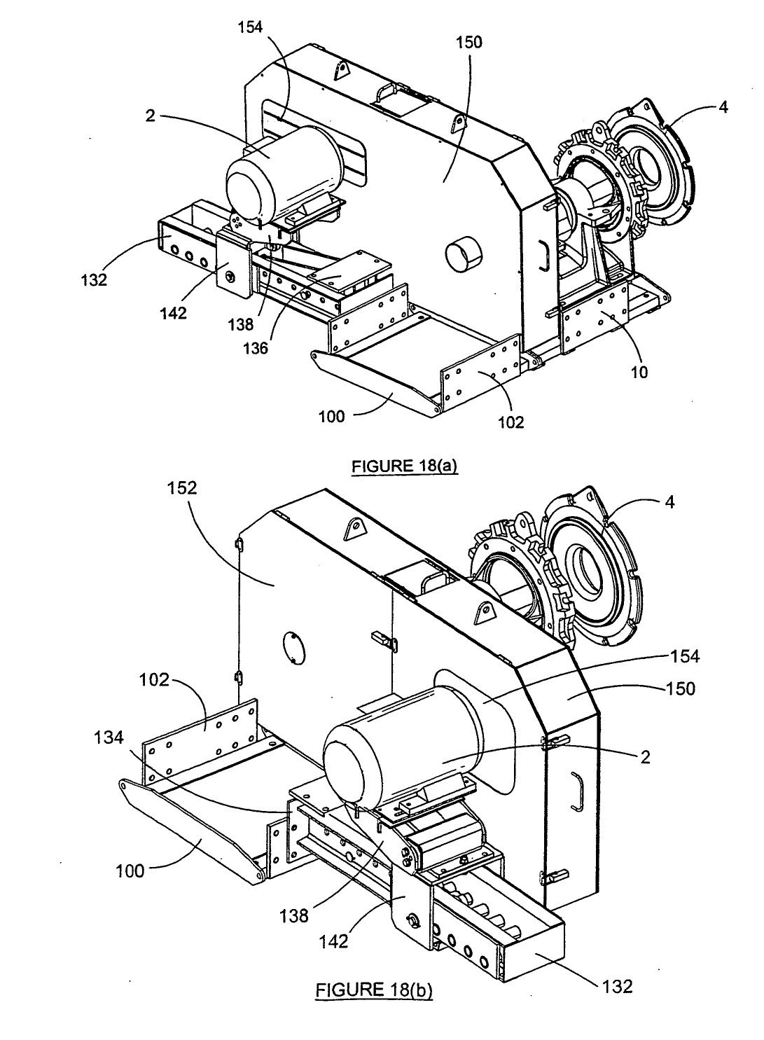

FIG. 18(a) is an isometric view of the drive means support base of FIG. 15(c), the driven means support base of FIG. 1(c), and the Z-adapter base of FIG. 6(c), all connected to each other in a first possible Z-alongside configuration;

FIG. 18(b) is an isometric view of the drive means support base of FIG. 15(c), the driven means support base of FIG. 1(c), and the Z-adapter base of FIG. 6(c), which are connected to each other in a second possible Z-alongside configuration;

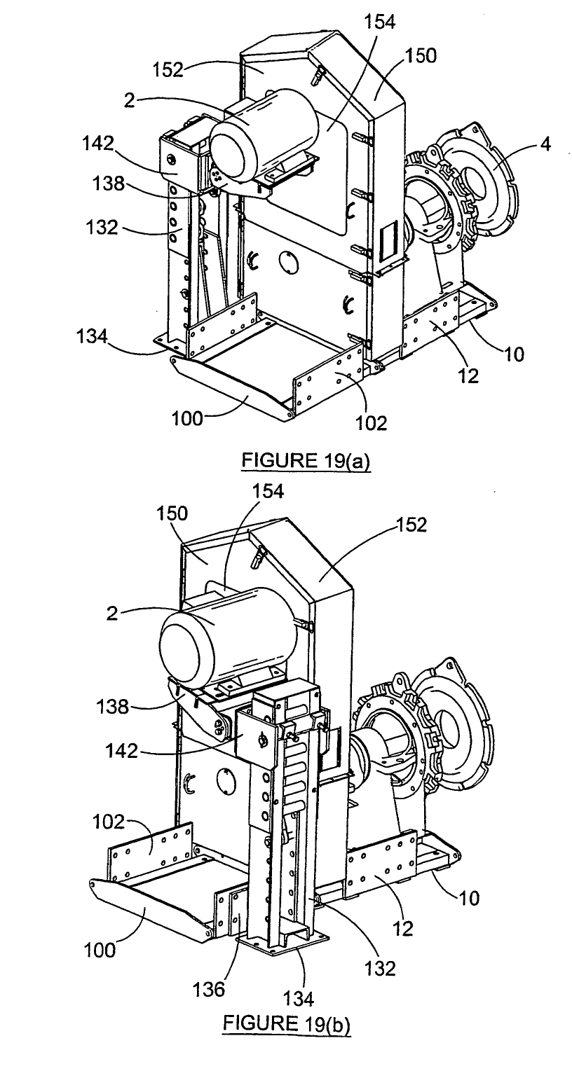

FIG. 19(a) is an isometric view of the drive means support base of FIGS. 15(a) and (b), the driven means support base of FIG. 1(c), and the Z-adapter base of FIG. 6(c), all connected to each other in a first possible Z-overhead configuration; and

FIG. 19(b) is an isometric view of the drive means support base of FIGS. 15(a) and (b), the driven means support base of FIG. 1(c), and the Z-adapter base of FIG. 6(c), connected to each other in a second possible Z-overhead configuration.

The modular mounting system according to the invention is adapted for mounting a drive means 2, such as an electrical motor, and a driven means 4, such as pump, of a mechanical power transmission system in various configurations relative to each other. The modular mounting system is not only aimed at facilitating easy access to the drive means 2 and driven means 4 in use and at facilitating easy alignment of the drive shafts 3 and driven shafts 5 during assembling, but also at providing a standard system comprising a number of disconnectably connectable modules that are adapted to engage each other in various configurations in order to create a variety of assembly configurations on site to accommodate different site requirements and operational demands.

The modular mounting system comprises a driven means support base 10 and at least one drive means support base. The driven means support base 10 includes two opposed side plates 12.1, 12.2; two opposed end plates 14.1, 14.2; and a base platform 16 for supporting the drive means 2 thereon. The side plates 12.1, 12.2 and the end plates 14.1, 14.2 each include a number of locating apertures 13 for receiving bolts, pegs, pins or like fasteners therethrough.

The driven means support base 10 also includes at least one mounting plate 18, which is connected to an end plate 14.1 in the embodiment in FIGS. 1(a) and (b), and to the base platform 16 in FIG. 1(c), and which includes a number of apertures 18.1 for accommodating bolts, pegs pins or the like connecting means therethrough for securing the driven means support base 10 to the ground or a like rigid surface in use.

Connected to the opposite end plate 14.2 [see embodiment in FIG. 1(a)], the driven means support base 10 includes a mounting bracket 20. The driven means support base 10 also includes a number of reinforcing nut plates 22 connected to an inner surface of the side plates 12.1, 12.2 for reinforcing the side plates 12.1, 12.2 and the locating apertures 13.

The invention also provides for a drive means support base. In one form of the invention, the modular mounting system includes an alongside drive means support base or so-called “alongside base” 30, as illustrated in FIGS. 2 and 3, which is mounted in an alongside configuration relative to the driven means support base 10. In an alternative or additional form of the invention, the modular mounting system includes an overhead drive means support base or so-called “overhead base” 70, as illustrated in FIGS. 4 and 5, which is mounted in an overhead configuration relative to the driven means support base 10. The drive means support base is particularly adapted for receiving an industrial a-synchronous squirrel-cage electrical motor.

The drive means support base illustrated in FIGS. 15 to 19, which is a more preferred embodiment of the invention and which is discussed in more detail hereunder, is adapted to be used either in an alongside or an overhead configuration and accordingly alleviates the need for the two separate alongside and overhead bases illustrated in FIGS. 1 to 5, although the principles applied in the embodiments of FIGS. 1 to 5 and 15 are the same.

Referring first to the alongside base 30 illustrated in FIGS. 2(a) to (d), the alongside base 30 is disconnectably connectable to the driven means support base 10 so as to define a closed load path between the drive and driven means. By connecting the drive and driven means support bases to each other, the applicant has overcome the difficulties experienced with conventional mounting configurations where the load path is defined through an external foundation.

The alongside base 30 includes a drive beam 34; an end-mounting plate 32 connected to one end of the drive beam 34 and dimensioned releasably to engage either of the side plates 12.1, 12.2 of the driven means support base 10; and a drive means receiving platform 36 which is mechanically linked to the drive beam 34 and suitably dimensioned for receiving the drive means 2 thereon.

The alongside base 30 includes tensioning means 38 which is movable between a tensioned and a substantially non-tensioned position such that in the tensioned position it is biased to the non-tensioned position for moving the alongside base 30. The tensioning means 38 is a Neidhart unit that is connected at both ends thereof to the drive means receiving platform 36 by means of a plug 35 and shear washer 37.

The drive means receiving platform 36 is displaceable relative to both the base platform 16 and the drive beam 34. More particularly, the alongside base 30 includes pre-stressing means 40 in the form of a hydraulically operable arm, which is pivotally connected at one end thereof to the drive beam 34 and pivotally connected at an opposite end thereof to the tensioning means 38 and the drive means receiving platform 38 by means of displacement bracket 41. The hydraulically operable arm 40 is adapted for moving the drive means receiving platform 36 while at the same time moving the tensioning means 38 towards its tensioned position. The hydraulically operable arm 40 can be activated either automatically or manually.

The drive means receiving platform 36 is pivotally connected to the drive beam 34 by means of an intermediate cover plate 42. The cover plate 42 is pivotally connected to the drive beam 34 by pivot pins 44. The cover plate 42 is also connected to the two opposite ends of the Neidhart tensioning means 38, which in turn is connected to the drive means receiving platform 36. The arrangement is such that the drive means receiving platform 36 is pivotable relative to the drive beam 34 at pivot pins 44 and is pivotable in the tensioning means 38 around axis 35.

The pre-stressing means 40 is connected to the drive beam 34 by means of mounting plate 46. Mounting plate 46 includes a few sets of apertures 47 through which mounting bolts or the like fasteners may extend, the arrangement being such that the pre-stressing means 40 is movably connected to the drive beam 34.

Similarly, the cover plates 42 are connected to the drive beam 34 by means of mounting plates 48. The mounting plates 48 each include at least three pin apertures 49 for accommodating the cover plates 42 at various positions on the mounting plates 48.

The drive means receiving platform 36 is transversely mountable to the longitudinal axis of the drive beam 34 in two positions that are 180° opposite to each other. In particular, the drive means receiving platform 36 can be disconnected from the drive beam 34, rotated by 180° and reconnected to the drive beam 34.

FIGS. 2(c) and 2(d) illustrate working of the alongside base 30, and particularly the characteristic dual pivoting capability of the drive means receiving platform 36. The drive means receiving platform 36 is simultaneously pivotable in the tensioning means 38 around axis 35 and in the pivot pin 44. In FIG. 2(c), the pre-stressing means 40 is in an extended condition to effect pre-stressing of a belt (not shown) between the drive means 2 and driven means 4 in use. In FIG. 2(d), the pre-stressing means 40 is in a retracted condition such that the belt between the drive means 2 and driven means 4 is in a substantially relaxed condition. As is apparent from the drawings, the pre-stressing means 40 itself is also pivotable within cylinder bracket 43.

The alongside base illustrated in FIG. 3 is designated by reference numeral 50 and is dimensioned for accommodating drive means of smaller frame sizes (typically motor frame sizes from 132 mm and smaller). The alongside base 50 also comprises a drive beam 52; an end-mounting plate 54; and a drive means receiving platform 56 that is mechanically linked to the drive beam 52. The alongside base 50 further includes a base mounting plate 60 for securing the base 50 to the ground in use.

The tensioning means 38 is a Neidhart unit which is connected at both ends thereof to the drive means receiving platform 56. Two pivot plates 58 are connected to and extend from the tensioning means 38 for pivotally connecting the drive means receiving platform 56 to the drive beam 52 by means of pivot pins 44.

The pre-stressing means of the alongside base 50 illustrated in FIG. 3 comprises of a threaded tensioner 62. The threaded tensioner 62 is tensioned by a rotating handle (not seen in the drawing) located at a rear end of the alongside base 50 just above the mounting plate 60.

Reference is now made to the overhead base illustrated in FIG. 4. The overhead base is designated by reference numeral 70 and is used for drive means of larger frame sizes (typically 160 mm and larger). Similarly to the alongside base, the overhead base 70 is disconnectably connectable to the driven means support base 10 in a number of mounting configurations. The overhead base 70 includes a drive beam 74; a side-mounting plate 72 disposed approximate a side of the drive beam 74 and dimensioned releasably to engage either one of the side plates 12.1, 12.2 of the driven means support base 10; and a drive means receiving platform 76 mechanically linked to the drive beam 74 and suitably dimensioned for receiving the drive means 2 thereon. The drive means receiving platform 76 is connected to and displaceable about a longitudinal axis of the drive beam 74 by means of height adjustment bracket 78.

The overhead base 70 includes tensioning means 80 in the form of a Neidhart unit that is connected at both ends thereof to the drive means receiving platform 76. The tensioning means 80 is movable between a tensioned and a substantially non-tensioned position such that in the tensioned position it is biased to the non-tensioned position for moving the drive means receiving platform 76.

In the overhead base 70 the drive beam 74 comprises of a telescopic shaft 74.1 and sleeve 74.2 arrangement. The drive means receiving platform 76 is mechanically linked to the telescopic shaft 74.1 and sleeve 74.2 arrangement of the drive beam 74 such that the receiving platform 76 is vertically movable relative to the driven means support base 10 about the longitudinal axis of the drive beam 74 by telescoping the shaft 74.1 and sleeve 74.2 arrangement. Telescoping of the drive beam 74 is achieved by means of pre-stressing means.

In the embodiment of the invention illustrated in FIG. 11(c) the pre-stressing means includes a hydraulically operable cylinder including a piston 82, which is adapted for effecting telescoping of the drive beam 74. The piston 82 is located in a piston barrel 84 between two plugs 86 which are spaced so as to define a hydraulic fluid chamber 92 between the plugs 86. A piston rod 88, which at its bottom end is arranged in mechanical cooperation with the piston 82, extends through the plug 86 and is connected at its opposite end to a taper-lock bush 90. The hydraulically operable piston arrangement is maintained in the telescopic shaft 74.1 and sleeve 74.2 arrangement of the overhead base drive beam 74 by means of cylinder securing pin 94.

Referring now to FIG. 5, the overhead base illustrated in this embodiment is designated by reference numeral 84 and is used for drive means of smaller frame sizes. It also includes a drive beam 86; a side-mounting plate 72 dimensioned releasably to engage the driven means support base 10; and a drive means receiving platform 76 mechanically linked to the drive beam 86 and suitably dimensioned for receiving the drive means 2 thereon. The drive means receiving platform 76 is connected to the drive beam by means of mounting plate 93 [see FIG. 12(c)].

The drive beam 86 also comprises of a telescopic shaft 86.1 and sleeve 86.2 arrangement and the drive means receiving platform 76 is mechanically linked to the telescopic shaft 86.1 and sleeve 86.2 arrangement such that the receiving plate 76 is movable relative to the driven means support base 10 by telescoping of the drive beam 86.

Telescoping of the drive beam 86 is achieved by means of pre-stressing means, which in this case is a threaded rod 88 and locking nut 90 arrangement [see FIG. 12(d)]. In particular, the threaded rod 88 is co-axially arranged in the drive beam 86. Threaded nut 89 is connected to sleeve 86.2, while threaded nut 91 is connected to shaft 86.1. Telescoping of the drive beam 86 is thus achieved by rotation of the rod 88, which extends through both nuts 89 and 91.

The modular mounting system further includes a Z-adapter base 100 [FIGS. 6(a) to (c)] which is locatable intermediate the drive means support base 10 and the driven means support base such that the drive means support base 10 and the driven means support base are arranged relative to each other in a Z-configuration.

The Z-adapter base 100 includes two opposed side plates 102.1, 102.2; and two opposed end plates 104.1; 104.2. The Z-adapter base 100 of FIG. 6(c) also includes a base plate 103. The drive and driven means support bases are disconnectably connected to the Z-adapter base 100 such that a drive means support base is connected to either side plate 102.1, 102.2 of the Z-adapter base 100, while the driven means support base 10 is connected to the end plate 104.1 of the Z-adapter base 100. The Z-adapter base 100 also includes reinforcing nut plates 101 connected to an inner surface of the side plates 102.1, 102.2 for reinforcing the same.

The Z-adapter base 100 further includes a number of locating apertures 106 arranged in the side plates 102.1, 102.2 and end plates 104.1; 104.2 for receiving fastening bolts therethrough. The Z-adapter base 100 also includes a mounting bracket 108 [FIG. 6(a)] connected to end plate 104.2, while end plate 104.1 includes a bracket aperture 110 [FIG. 6(b)] for accommodating the mounting bracket 20 of the driven means support base 10.

In erecting the standard alongside configuration, as illustrated in FIGS. 7(a) and 8(a), end-mounting plate 32 (or 54) of alongside base 30 (or 50) is connected to either side plates 12.1, 12.2 of the driven means support base 10. Both the driven means support base 10 and the alongside base 30 (or 50) are secured to the ground by means of bolts, pegs, pins or the like connecting means 6.

Similarly, when erecting the standard overhead configuration, as illustrated in FIGS. 11(a) and 12(a), side-mounting plate 72 of overhead base 70 (or 84) is connected to either side plates 12.1, 12.2 of the driven means support base 10.

In erecting the Z-alongside configuration as illustrated in FIG. 9(a), the end-mounting plate 32 of the alongside base 30 is connected to the side plate 102.2 of the Z-adapter base 100. In turn, the end plate 14.2 of the driven means support base 10 is connected to the end plate 104.1 of the Z-adapter base 100 such that bracket 20 of the driven means support base 10 protrudes through bracket aperture 110 of the Z-adapter base 100. It should be appreciated that the alongside base 30 is connectable to either side plate 102.1 or 102.2 of the Z-adapter base 100 in this configuration.

In the Z-alongside configuration illustrated in FIG. 10(a), which is suitable for drive means frame sizes of 132 mm or less, the driven means support base 10 has been extended to effectively- “incorporate” the Z-adapter base so that the drive means 2 and driven means 4 are mountable in a Z-configuration without the need for a separate Z-adapter base. A similar principle applies in the Z-overhead configuration illustrated in FIG. 14(a).

In erecting the Z-overhead configuration illustrated in FIG. 13(a), the side-mounting plate 72 of the overhead base 70 is connected to the side plate 102.2 of the Z-adapter base 100. It will again be appreciated that the overhead base 70 is connectable to either side plate 102.1 or 102.2 of the Z-adapter base 100 in this configuration. The end plate 14.2 of the driven means support base 10 is again connected to the end plate 104.1 of the Z-adapter base 100 such that bracket 20 of the driven means support base 10 protrudes through bracket aperture 110 of the Z-adapter base 100.

Reference is now made to FIGS. 15 to 19, which illustrate a drive means support base, designated 130, and which is adapted to be either an overhead base or an alongside base, thus effectively alleviating the need for two separate bases as described hereinbefore. The drive means support base 130 includes a drive beam 132 to which two mounting plates are connected, namely an end-mounting plate 134, which is connected to one end of the drive beam 132; and a side-mounting plate 136, connected to a side of the drive beam 132. The mounting plates 134 and 136 are dimensioned releasably to engage either of the side plates 12 of the driven means support base 10 illustrated in FIG. 1(c) for the standard configurations [see FIGS. 16 and 17]; or the side plates 102 of the Z-adapter base 100 of FIG. 6(c) when used in the Z-configurations [see FIGS. 18 and 19].

The drive means support base 130 also includes a drive means receiving platform 138, which is connected to the drive beam 132 for receiving the drive means 2 thereon. The drive means receiving platform 138 is connected to the drive beam 132 by means of bracket 142 and is pivotally displaceable relative to the drive beam 132 in pivot point 140. It is also linearly displaceable on the drive beam 132 in that the bracket 142 can be connected to the drive beam 132 at various positions along its length.

As said hereinbefore, the drive means support base 130 can be mounted relative to the driven means support base 10 either in an overhead configuration, in which the drive beam 132 is orientated vertically upright in a plane substantially perpendicular to the plane of the base platform 16 [as illustrated in FIGS. 17 and 19]; or in an alongside configuration, in which the drive beam 132 is orientated in substantially the same plane as the base platform 16 [FIGS. 16 and 18].

The drive means support base 130 includes pre-stressing means 144 in the form of a hydraulically operable arm for pivoting the drive means receiving platform 138 relative to the drive beam 132. The hydraulically operable arm 144 is pivotally connected at one end thereof to the drive beam 132 and pivotally connected at an opposite end thereof to the drive means receiving platform 138. The hydraulically operable arm 40, which can be activated either automatically or manually, is adapted to move the drive means receiving platform 138 while at the same time moving the tensioning means 38 towards its tensioned position.

FIGS. 16 to 19 also illustrate a belt guard 150 for use with the mounting system according to the invention. The belt guard 150 covers the belt extending between the drive and driven means 2 and 4 to prevent injury to users or bystanders, especially in the unlikely event that the belt may dislodge itself from the drive and/or driven means while running. The belt guard 150 includes two opposed parallel sidewalls 152 spaced from each other to define a belt path between them suitable for housing the belt (not seen in the drawings). The belt guard 150 provides access to the belt in use through doors 154. The belt guard 150 is releasably connected to either one or both of the drive and driven means support bases.

The invention concerns a modular mounting system adapted for accommodating substantially any motor size in a range wherein the relative positioning between the shaft shoulders of the drive and driven means is such that the shaft shoulders are always orientated in alignment and parallel to each other irrespective of the configuration of the modules of the system. In addition, the system provides a series of interchangeable drive and driven means support bases, as well as an open structure design for permitting easy access to both the drive means and driven means in use.

It will be appreciated that many other embodiments and configurations of the invention are possible without departing from the spirit or scope of the invention as defined in the claims.

1. A mounting system suitable for mounting drive and driven means of a mechanical power transmission system relative to each other, the mounting system comprising a set of interchangeably connectable modules characterised therein that they can be altered to adapt the same mounting system for various different drive-and-driven-means configurations and further characterised therein that the modules of the system are interchangeably connectable in such a way that a drive shaft and a driven shaft of drive and driven means mounted on the mounting system are aligned and orientated parallel to each other in use, and particularly such that shaft shoulders of the drive and driven shafts are aligned, in anyone of the mounting configurations such that there is a straight belt path between the two shafts at all times.

2. The mounting system as claimed in claim 1 characterised therein that comprises a drive means support base; and a driven means support base, the drive means support base and driven means support base being characterised therein that they are disconnectably connected to each other in a first mounting configuration mount the drive and driven means in the first configuration relative to each other, and being re-connectable to each other in a second alternative mounting configuration to mount the drive and driven means in the second configuration.

3. The mounting system as claimed in claim 2 characterised therein that the driven means support base includes at least one base platform for supporting the driven means thereon; and engagement means for permitting releasable engagement with the drive means support base.

4. The mounting system as claimed in claim 3 characterised therein that the driven means support base also includes two opposed side plates and two opposed end plates connected to and extending from the base platform.

5. The mounting system as claimed in claim 2 characterised therein that the drive means support base is disconnectably connected either to the ground or a like rigid surface approximate the driven means support base, or to the driven means support base itself and particularly to anyone of the opposed side plates or end plates of the driven means support base.

6. The mounting system as claimed in claim 2 characterised therein that the drive means support base includes a drive beam; at least one mounting plate connected to the drive beam and dimensioned releasably to engage either of the side plates or end plates of the driven means support base; and a drive means receiving platform mechanically linked to the drive beam and suitably dimensioned for receiving the drive means thereon.

7. The mounting system as claimed in claim 6 characterised therein that the drive means support base includes at least one end-mounting plate connected to an end of the drive beam and at least one side-mounting plate connected to a side of the drive beam.

8. The mounting system as claimed in claim 6 characterised therein that the drive means receiving platform is pivotally displaceable relative to the drive beam and linearly displaceable parallel to the longitudinal axis of the drive beam.

9. The mounting system as claimed in claim 6 characterised therein that the drive beam comprises of a telescopic shaft and sleeve arrangement.

10. The mounting system as claimed in claim 9 characterised therein that the drive means receiving platform is mechanically associated with the telescopic shaft and sleeve arrangement, the arrangement being such that the drive means receiving platform is movable along the longitudinal axis of the drive beam and linearly relative to the base platform through telescoping the drive beam.

11. The mounting system as claimed in claim 9 characterised therein that telescoping of the shaft and sleeve arrangement is achieved by means of a threaded rod or the like mechanical adjustment means located in the drive beam; or by means of a hydraulic cylinder arranged within the drive beam for telescoping the same.

12. The mounting system as claimed in claim 1 characterised therein that the drive means support base is mounted relative to the driven means support base either in an overhead configuration, in which the drive beam is orientated vertically upright in a plane substantially perpendicular to the plane of the base platform; or in an alongside configuration, in which the drive beam is orientated substantially the same plane as the base platform, the arrangement being such that when the drive means support base and driven means support base are orientated in the overhead configuration, the drive means and driven means are substantially vertically spaced from each other, while in the alongside configuration, the drive and driven means are substantially horizontally spaced from each other.

13. The mounting system as claimed in claim 1 characterised therein that the same drive means support base is mountable relative to the driven means support base in either one of the overhead or alongside configurations.

14. The mounting system as claimed in claim 2 characterised therein that the drive means support base is selected from one of two designs, namely an overhead drive means support base (“overhead base”) and an alongside drive means support base (“alongside base”).

15. The mounting system as claimed in claim 1 characterised therein that the drive means support base includes tensioning means which is movable between a tensioned and a substantially nontensioned position such that in the tensioned position it is biased to the nontensioned position for moving the drive means support base, the arrangement being such that when the tensioning means is in the tensioned position, a belt is optimally tensioned between the drive and driven means, and when the tensioning means is in the substantially non-tensioned position, the belt is non-optimally tensioned.

16. The mounting system as claimed in claim 15 characterised therein that the tensioning means is resilient biasing means such as a spring, torsion element or a Neidhart unit.

17. The mounting system as claimed in claim 1 characterised therein that it includes pre-stressing means, which is adapted for effecting displacement of the drive means receiving platform relative to the base platform for manipulating distance between drive and driven means mounted on these respective platforms, thereby manipulating belt tension of a belt extending between the drive and driven means use, the pre-stressing means further being adapted to move the drive means receiving platform while at the same time moving the tensioning means towards its tensioned position.

18. The mounting system as claimed in claim 17 characterised therein that the pre-stressing means is a hydraulically operable arm pivotally connected at one end thereof to the drive beam and pivotally connected at an opposite end thereof to the drive means receiving platform the arrangement being such that extension and retraction of the hydraulic arm effects pivoting of the drive means receiving platform about the drive beam.

19. The mounting system as claimed in claim 17 characterised therein that the pre-stressing means is self-adjusting and adapted for continuously moving at least the drive means receiving platform substantially immediately upon occurrence of belt slacking while the belt is running.

20. The mounting system as claimed in claim 2 characterised therein that the drive means receiving platform is manually adjustable relative to the driven means support base while the belt is running.

21. The mounting system as claimed in claim 1 characterised therein that it further includes a Z-adapter base which is removably locatable intermediate the drive means support base and the driven means support base such that the drive means support base and the driven means support base are arranged relative to each other in a substantially Z-configuration.

22. The mounting system as claimed in claim 21 characterised therein that the Z-adapter base is locatable between the drive and driven means support bases either in a Z-overhead configuration, in which the drive beam is orientated vertically upright in a plane substantially perpendicular the plane of the base platform; or in a Z-alongside configuration, in which the drive beam is orientated in substantially the same plane as the base platform.

23. The mounting system as claimed in claim 22 characterised therein that in the Z-overhead configuration the side-mounting plate of the drive means support base is connected to the Z-adapter base, which in turn is connected to the driven means support base in such a way that the drive means and driven means are substantially vertically spaced from each other in a Z-configuration; whereas in the Z-alongside configuration the end-mounting plate of the drive means support base is connected to the Z-adapter base, which in turn is connected to the driven means support base such that the drive and driven means are substantially horizontally spaced from each other in a Z-configuration.

24. The mounting system as claimed in claim 21 characterised therein that the Z-adapter base includes a base plate orientated in substantially the same plane as the base platform; two opposed side plates; and two opposed end plates connected to the base plate; and engagement means suitable for engaging the drive and driven means support bases.

25. The mounting system as claimed in claim 24 characterised therein that the drive and driven means support bases are disconnectably connected to the Z-adapter base such that the drive means support base is connected to either one of the side or end plates of the Z-adapter base, while the driven means support base is connected to either one of the other of the end or side plates of the Z-adapter base, as the case be.

26. The mounting system as claimed in claim 1 characterised therein that it also includes at least one belt guard adapted at least partially to cover a belt extending between the drive and driven means and including at least two opposed parallel sidewalls spaced from each other to define a belt path between them suitable for housing the belt, and further being characterised therein that it provides access to the belt in use.

27. A drive means support base suitable for cooperating with a driven means support base in a modular mounting system, the drive means support base comprising a drive beam; mounting means connected to the drive beam for mounting the drive means support base either to the ground or the like rigid surface, or to the driven means support base; and a drive means receiving platform mechanically linked to the drive beam and suitably dimensioned for receiving the drive means thereon.

28. The drive means support base as claimed in claim 27 characterised therein that it includes tensioning means connected the drive means receiving platform and movable between a tensioned and a substantially non-tensioned position such that in the tensioned position it is biased to the non-tensioned position for moving the drive means receiving platform.

29. The drive means support base as claimed in claim 27 characterised therein that it also includes pre-stressing means which is adapted for effecting displacement of the drive means receiving platform relative to the driven means support base for manipulating distance between drive and driven means respectively mounted on the drive means receiving platform and the driven means support base, thereby manipulating belt tension of a belt extending between the drive and driven means in use, the pre-stressing means further being adapted to move the drive means receiving platform while at the same time moving the tensioning means towards its tensioned position.

30. A Z-adapter base suitable for use in a modular mounting system including a drive means support base for supporting a drive means thereon, and a driven means support base for supporting driven means, the Z-adapter base being locatable intermediate the drive and driven means support bases such that the drive and driven means support bases are arranged relative to each other in a substantially Z-configuration.

31. The Z-adapter base as claimed in claim 30 characterised therein that the Z-adapter base includes a base plate; two opposed side plates and two opposed end plates connected to the base plate; and engagement means suitable for engaging the drive and driven means support bases.

32. The Z-adapter base as claimed in claim 30 characterised therein that the drive and driven means support bases are disconnectably connected to the Z-adapter base such that the drive means support base is connected to either one of the side or end plates of the Z-adapter base, while the driven means support base connected to either one of the other of the end or side plates of the Z-adapter base, as the case be.

33. A belt guard adapted at least partially to cover a belt extending between a drive and driven means and including at least two opposed parallel sidewalls spaced from each other to define a belt path between them suitable for housing the belt, and further being characterised therein that it provides access to the belt in use.

34. A mounting system substantially as herein illustrated and exemplified with reference to the accompanying drawings.

35. A drive means support base substantially as herein illustrated and exemplified with reference to the accompanying drawings.

36. A Z-adapter base substantially as herein illustrated and exemplified with reference to the accompanying drawings.

37. A belt guard substantially as herein illustrated and exemplified with reference to the accompanying drawings.
